(19) United States
(12) Patent Application Publication
(10) Pub. No.: US 2004/0193703 A1
(43) Pub. Date: Sep. 30, 2004

(54) System and method for conformance and governance in a service oriented architecture

(76) Inventors: Guy Loewy, Cambridge, MA (US); Mordechai Vaknin, Brookline, MA (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/753,383

(22) Filed: Jan. 9, 2004

Related U.S. Application Data
(60) Provisional application No. 60/439,275, filed on Jan. 10, 2003.

(51) Int. Cl. G06F 15/177

(52) U.S. Cl. 709/220

(57) ABSTRACT

Systems and methods to enable conformance and governance of a multitude of applications, services, documents and projects etc. in distributed, multi-user environments. Enterprise policies may be defined and configured. Interface documents may be compared to the pre-defined enterprise policies, to determine the interface document's conformance with the policies. Results of the comparison may be reported, and management or governance of the policies across the distributed architecture may be enabled.

### CROSS REFERENCE TO RELATED APPLICATIONS

This application claims priority from U.S. Provisional Patent Application No. 60/439,275, filed Jan. 10, 2003, entitled “DEVICE, SYSTEM AND METHOD FOR GOVERNANCE OF XML AND WEB SERVICES IMPLEMENTATIONS”, which is incorporated in its entirety herein by reference.

### FIELD OF THE INVENTION

The present invention relates to methods and devices useful in implementing network services. Specifically, embodiments of the present invention relate to systems, methods, and apparatuses that provide conformance and/or governance in, for example, a distributed architecture.

### BACKGROUND OF THE INVENTION

XML and Web Services represent a major promise in the space of Enterprise and eBusiness Application Integration. The promise is that Enterprise and eBusiness Application Integration standards, such as Extensible Markup Language (XML), Simple Object Access Protocol (SOAP) and Web Services Description Language (WSDL), will enable the creation of a unified Service Oriented Architecture in which business functions will be represented via Web Services. These Web Services may become plug-and-play components that may be implemented easily by new applications, portals, etc.

However, standards may not be enough in order to create a true Service Oriented Architecture. The business layer, dictionaries and semantics, security, interoperability and implementations profiles are only few of a long list of elements that require Enterprise Policies in place in order to really achieve a scalable Service Oriented Enterprise.

Leading enterprises that have selected XML, Web Services and Service Oriented Architecture as their integration paradigm understand this problem and are generally investigating ways to resolve it. Some are trying to solve the problem through the establishment of a centralized governance body and are planning on manually reviewing and approving interface development. It is not a scalable, manageable, and knowledge building process, and it usually gets a strong push back from the development teams. The challenge is how to achieve conformance and governance without forcing additional costs, time, resources and manual steps in the process.

### SUMMARY OF THE INVENTION

There is provided, in accordance with embodiments of the present invention, an apparatus, system, and method for enabling conformance and governance in for example a distributed architecture.

According to one embodiment of the present invention, a method is provided to configure a policy, the policy including one or more policy elements, such that the policy is applicable to a plurality of interface document types; and to compare one of a plurality of interface documents of the plurality of interface document types to the policy. The interface document may be conformed to the policy.

The policy configuring process, in some embodiments, may include defining a policy element; providing configuration parameters for the policy element; and providing a policy definition that includes one or more policy elements. Conflicts between policy elements in a selected policy may be resolved. The comparison process, in some embodiments, may include initiating an automated compliance test on the interface document. In another embodiment the comparison process may include uploading an interface document; performing a compliance test on the interface document; and reporting the results of the compliance test. Uploading may include, for example, uploading, referring to, transferring, accessing or otherwise entering, manually or automatically, a file or document.

The policy conforming process, in some embodiments, may include raising an exception request to a policy element; if a policy element is not approved to be an exception, correcting the interface document; and if a policy element is approved to be an exception, granting conformance to the policy element. In another embodiment the conformance procedure may include initiating a compliance test such that a pass or not pass result is determined, based on the information in the interface document and the policy element. A further embodiment may include determining whether an interface document provides enough information for running a compliance test to determine whether a said policy element is to be passed; where the interface document provides enough information, checking whether the policy element provides a guided interaction process defined based on results from the compliance test; and if the policy element does not provide a guided interaction definition, determining whether to pass the conformance of the interface document to the policy element. In one embodiment the conforming procedure may include conforming the interface document to the policy element by reviewing the interface document by one or more users.

According to some embodiments of the present invention, conformance may be governed by initiating an exception request to a policy; distributing a exception request to a relevant user; performing an analysis on the impact of the exception request; and resolving the exception request by granting or not granting an approval. In further embodiments governing may include providing a user with a list of potentially reusable interfaces components; analyzing potential reusability of interfaces components, based on a provided list and project information; and determining which interfaces components may be re-used. Furthermore, a cost analysis associated with selected reusable interfaces components may be performed. Additionally, relevant users may be alerted as to the assignment of reusability guidelines to an interface document.

In another embodiment, governing may include, when a change in a policy element is made or when a new policy element is added, testing whether a policy element change or addition conflicts with other policy elements that are defined in a policy; and if there is a conflict, generating a conflict alert. The system may analyze the impact of solving such a conflict. For example, the system may generate an impact analysis report that includes a description of an impact of a conflict on an interface document. After a conflict has been resolved, the policy element change may be applied to a policy. In a further embodiment governing may include notifying relevant users about an escalation process being initiated for an interface document; and receiving a response from a relevant user escalating the response. In another embodiment a plurality of policies to be assigned may be selected; the plurality of policies may be assigned to an interface document; and it may be determined whether conflicts occur between policy elements of the plurality of policies. Relevant users may be alerted as to the policy assignment. The policy assignment may be negotiated between the relevant users. Another governing embodiment may include defining global cost parameters for a set of interface documents; defining alerting rules associated with the global cost parameters; recording information relating to development of the interface documents; analyzing recorded information according to said global cost parameters; and generating alerts to relevant users, according to the information analysis.

According to some embodiments of the present invention, a method may be provided, including associating in a computer system a policy to a plurality of interface document types used in a distributed architecture; uploading interface documents created in one of the interface document types; and analyzing the interface documents according to the policy. A set of policies may be assigned to a project or other suitable grouping, the policies being selected from a plurality of sets of policies. A relevant user may be alerted about the conformance status of an interface document to the policy.

In some embodiments of the present invention a guided conformance procedure may be performed. In some embodiment exception requests may be managed for the policy. Such managing may include initiating an exception request to the policy; distributing the exception request to a relevant user; performing an analysis on the impact of the exception request; and resolving the exception request by granting or not granting an approval. In some embodiments a reusability procedure may be initiated in a distributed architecture, potential policy conflicts may be managed, an effect of a policy change may be analyzed, and/or cost parameters associated with development of the interface documents may be managed.

According to some embodiments of the present invention, a policy may be created that includes conformance rules, such that the policy may be applicable to an interface document of a certain type, the type being one of a plurality of types, the policy able to be applied to interface documents in a distributed architecture. In some embodiment the policy may be applicable to a plurality of document types. Interface documents from a plurality of interface document types may be conformed to the policy.

According to one embodiment of the present invention, a set of policies may be assigned to a project, the set of policies being selected from a plurality of sets of policies; and relevant users may be alerted about the assigned set of policies. Conflict resolution may be conduced when assigning a set of policies to a project. A set of policies may be assigned to a plurality of projects in a distributed environment.

According to one embodiment of the present invention, a method may be provided that includes storing a plurality of policies in a computer system, each policy including at least a set of conformance rules, and each policy applicable to a plurality of interface document types; assigning a policy to the interface document types; and conforming the interface documents from the plurality of interface document types to the policy.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic illustration of a system according to some embodiments of the present invention;

FIG. 2 is a flowchart illustrating a method according to some embodiments of the present invention;

FIG. 3 is a schematic illustration of a high level view of basic interaction scenarios, according to some embodiments of the present invention;

FIG. 4 is a high level schematic illustration of a System User Interface, System server and System Repository, according to an embodiment of the present invention;

FIG. 5 is a schematic illustration of exemplary user interface modules, according to an embodiment of the present invention;

FIG. 6 is a schematic illustration of a System Server, according to an embodiment of the present invention;

FIG. 7 is a schematic illustration of a System Repository, according to an embodiment of the present invention;

FIG. 8 is a flow chart illustrating a Policy Definition Process, according to an embodiment of the present invention;

FIG. 9 is a flow chart illustrating a manual conformance process, according to an embodiment of the present invention;

FIG. 10 is a flow chart illustrating a system conformance process, according to an embodiment of the present invention;

FIG. 11 is a flow chart illustrating a guided conformance process, according to an embodiment of the present invention;

FIG. 12 is a flow chart illustrating an Exception Governance process, according to an embodiment of the present invention;

FIG. 13 is a flow chart illustrating an Escalation Governance Process, according to an embodiment of the present invention;

FIG. 14 is a flow chart illustrating a policy assignment process, according to an embodiment of the present invention;

FIG. 15 is a flow chart illustrating a reusability governance process, according to an embodiment of the present invention;

FIG. 16 is a flow chart illustrating an assistance process, according to an embodiment of the present invention;

FIG. 17 is a flow chart illustrating a conflict analysis process, according to an embodiment of the present invention;

FIG. 18 is a flow chart illustrating an impact analysis process, according to an embodiment of the present invention;

FIG. 19 is a flow chart illustrating a cost analysis configuration process, according to an embodiment of the present invention; and

FIGS. 20-26 are examples of screenshots according to embodiments of the present invention.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description herein. In addition, embodiments of the present invention may be implemented with any programming language. It will be appreciated that a variety of programming languages may be used to implement the teachings of the inventions as described herein.

Embodiments of the system and method of the present invention may enable conformance and governance of a multitude of applications, services, documents, and projects or other groupings etc. in a distributed architecture, for example, a Service Oriented Architecture (SOA), or elements thereof. For example, such conformance and governance may be enabled in distributed, multi-user environments, for example, in an enterprise, organization, and governmental body or between such entities etc. Conformance and governance may include, for example, policy management, conformance management, and governance of centralized policies or rules across the distributed architecture.

Centralized policies or rules may be applied, according to some embodiments of the present invention, to one or more interface documents and a plurality interface document types in a distributed architecture or environment. Interface documents as described herein may refer to, for example, documents, parts of documents, code elements, applications, engines, services and other suitable interface elements or tools etc., that may be created, developed, designed, or otherwise used by users in a distributed environment. Interface document types as described herein may refer to types of documents used or created with various suitable applications, development platforms, integrated development environments, programming languages, interface languages, meta-languages, service protocols, and software tools etc. that may be used to create or develop interface documents. For example, users (e.g., developers, system architects, editors, managers, end users etc.) may use a variety of interface document types to design or otherwise use interface documents in a distributed environment.

For example, interface documents may be created using interface document types including eXtensible Markup Language (XML), Web Service Inspection Language (WSIL), Universal Description, Discovery and Integration (UDDI), Lightweight Directory Access Protocol (LDAP), Simple Object Access Protocol (SOAP), Concurrent Versions System (CVS), Java DataBase Connectivity (JDBC) implementations, or other suitable languages, protocols, etc. An interface document may be, for example, an XML Schema document, WSDL document, C# code file, service metadata described in UDDI registry, etc.

A system server, according to some embodiments of the present invention, may be used as a point of reference to any integration or development project, to develop, for example, high quality Web Services and/or to analyze and re-use existing XML and Web Services based interfaces.

Such a system may enable users such as policy makers including architects, project leaders, enterprise application development leaders, etc. to, for example, define configure and assign polices in a coherent and manageable manner. Through, for example, a centralized graphical user interface, policy makers may be able to use policy templates, configure policy elements or conformance rules, and assign these elements to projects and domains on, for example, the enterprise level or the multi-enterprise level. Such a system may enable interface documents, applications, or services created by users, developers, architects, and system engineers etc. to automatically or semi-automatically conform to pre-defined policies. Such conformance may be enabled using an automatic system that provides easy to capture requirements, recommendations, best practices, etc. in one or more selected languages. A policy element or conformance rule may be a rule or comparison that may be applied to one or more interface documents, for example, created in respective languages or environments, to evaluate the document(s) in accordance with a centralized policy.

Once policies are defined, and conformance processes are in place, users such as policy and decision makers may be able to, for example, govern implementation, encourage reusability, manage collaboration processes, and analyze business metrics, thereby enabling policy integration. Such a system may provide a comprehensive interface, such as a dashboard, that may help provide effective tracking for all the system elements.

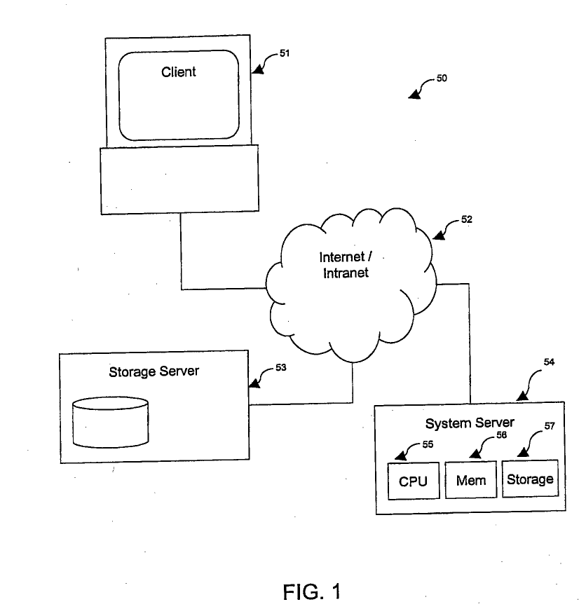

Reference is now made to FIG. 1, which depicts an architecture (e.g., a Service Oriented Architecture (SOA)) 50 according to one embodiment of the present invention. System server 54 may include, for example, a processor 55, a memory 56 (e.g., a RAM, ROM, etc.), and a mass storage device (e.g., hard disk, CD-ROM, etc) 57. Server 54 may be, for example, a workstation, etc. System server 54 may be connected to a network such as the Internet or Intranet 52, to a storage server 53 and to at least one client computer system 51, for example, a personal computer, a workstation, etc. Storage server 53 may provide, for example, mass storage or processing capability. Client computer system 51 may provide a suitable thin or fat client application, for example, a browser application or another suitable application for presenting a graphic user interface to a user. The various processes and methods described herein may be executed on a computer system such as system server 54. In alternate embodiments, a system other than such as system server 54 may be used. More than one computing unit may be used, and the various processes involved in embodiments of the present invention may be distributed across various processes. While in one embodiment one site is shown for the processing and storage capabilities of a system, in other embodiments such capabilities may be spread over multiple sites, including multiple processing devices, data storage units, etc. FIG. 1, and all the figures presented herein, is provided as an example only, and various embodiments of the invention may differ from the examples described or illustrated.

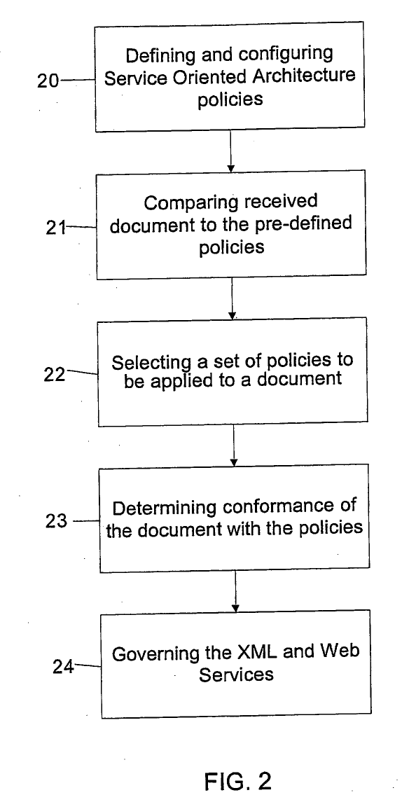

Reference is now made to FIG. 2, which depicts a method of governance and/or conformance of interface documents, interface languages, applications, and projects in distributed, multi-user environments, according to some embodiments of the present invention. At block 20 an enterprise architect may define and configure enterprise policies. For example, a set of policies (a set, when used herein, may include one), policy elements, or conformance rules that define interface languages, meta-languages, or other interface documents may be defined. At block. 21 a system server 54 may accept an interface document, application or service containing data relating to, for example, Enterprise and/or eBusiness Applications etc. (e.g., a document with XML, SOAP and/or WSDL data etc.) from a data communications network 52. At block 22 a user may select a set of policies to be applied by an interface document. At block 23 system server 54 may compare the received interface document to the pre-defined enterprise policies, to determine the interface document's conformance with the policies. At block 24 the system may report the results of the comparison, and/or may enable management or governance of the policies across the SOA.

For example, a set of policies that define interface languages, meta-languages, or other documents may be defined. A policy typically describes rules (termed herein policy elements or conformance rules) for interface documents to follow, regarding, for example, programming code practices, language usage, text or user interface presentation, memory usage, etc. A policy may include procedures for implementing those rules, for example when to ask a user or author a certain question, when to alert a manager or other authority, when and how to automatically analyze an input document, etc. For example, a policy may set rules limiting profanity or requiring a certain spell check application to be applied to a user interface. A policy may limit the size of code or may limit the use of certain types of programming code or routines. A policy may require the use of a password or other security usage in conjunction with certain actions, data structures, or services. A policy may require that when a certain event or aspect of an interface document is presented, a question be asked to a user or author. A policy may be applied to different document types, or policies may be applied to documents of specific types. Other policy types may be used.

In one embodiment, the system may have the capability of defining and processing centralized policies, and applying the policies to interface documents created from a broad array of document types. For example, different plug-in interpreters may be used for different environments, and additional plug-in interpreters may be added to address additional interface document types as they are needed. Each such plug-in interpreter may implement a similar set of basic operations that may be defined within a test in a Policy Element. Such operations may be extended over time to address new requirements for defining policy tests. For example, a Test Engine may interpret a test from a Policy Element to a set of XPath expressions in order to check an XML based interface document, for example WSDL document, while interpreting the same test to a set of java operations in order to check RMI based interface, etc. For example, the same system may accept policies and documents having types relating to, for example, XML, Web Services, SOAP, WSDL, etc. One system may process policies and documents of different types, thereby enabling integration of applications or projects etc. created by distributed users.

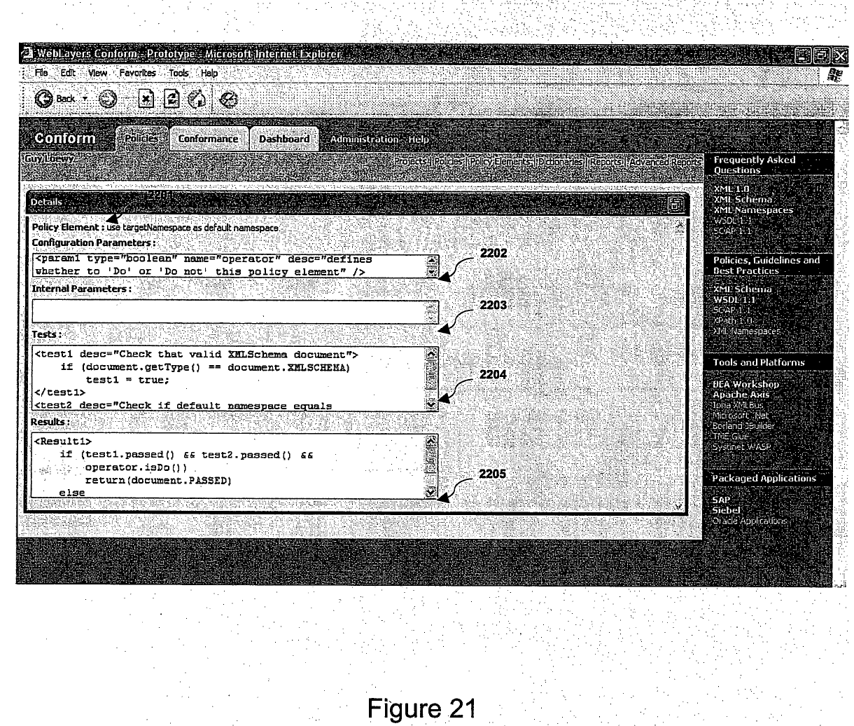

In one embodiment, the policies that may be defined may be stored, for example, as relational documents, objects, source code, etc. For example, as can be seen with reference to FIG. 21, the policy details that may be included in a page may include policy element 2201, configuration parameters 2202, internal parameters 2203, tests 2204, results 2205 etc., as are described in detail herein. As part of the policy element definition interface, interface documents may be configured to be tested for conformance for that particular policy element.

According to some embodiments of the present invention, a method may be provided that includes, for example, accepting a policy including a set of conformance rules, applying the policy to the document, and reporting the results of the conformance of the policy to the document. In one embodiment at least one of the conformance rules may result in a query to a user, for example, if a certain element exists in the document. In some embodiments, a “pass” or “not pass” may be generated for a comparison of each conformance rule (or for each of a set of conformance rules) to the interface document. In some embodiments the policies and/or conformance rules may be centrally governed or managed using, for example, a dashboard or other centralized user interface. Where necessary, an escalation process may be initiated for a policy, which may include, for example, allowing a policy to be overridden by an appropriate authority. The above methods may be implemented, for example, by a controller, which may be capable of accepting different policies among a plurality of policies, each of the policies being applicable to a different type of interface document or the same type of interface document.

According to some embodiments of the present invention, a method is provided that may include, assigning in a computer system a set of policies to a project or any other suitable interface document, the set of policies being selected from a plurality of sets of policies; and alerting a relevant user about the assigned policies. For example, an alert message may be sent to a user informing him/her of, e.g., an interface document that does not conform to a policy. In one embodiment a user may be alerted to inappropriate programming code, for example, by providing real time error alerts when the user is writing such code. This may be, for example, similar to an automatic spell check or grammar check that may alert a user as to possible spelling or grammar errors during drafting of a document. In some embodiments a project level conflict resolution may be conducted. In some embodiments one or more policies in the set of assigned policies may be negotiated.

According to some embodiments of the present invention a method may be provided to accept a policy selection indicating a subset of policies from a set of policies, each policy including a set of conformance rules; and applying the policy selection to a document or set of interface documents, for example as described above, by alerting the user as to possible non-conformance with one or more policies. In some embodiments the results of the conformance of the policy to the interface document may be reported, to, for example, a user. In some embodiments the set of policies may include policies relevant to different types of documents.

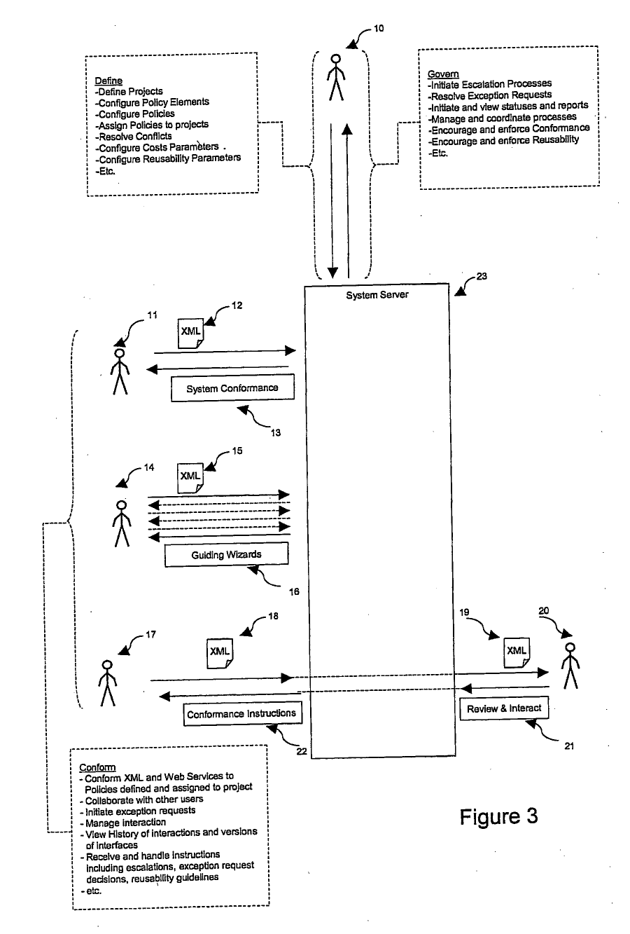

Reference is now made to FIG. 3, which is a schematic diagram illustrating a high-level view of exemplary interaction scenarios with system 50, according to an embodiment of the present invention. A user 10, who may be, for example, an enterprise architect, manager, etc, may interact with the system server 23 and may, for example, define projects, configure policies and policy elements or conformance rules, assign policies to projects, resolve conflicts between variety of policy elements, configure costs parameters, etc. Users 11, 14 and 17 may conform or be forced to conform to the assigned policies, in one embodiment, that may be dictated by, for example, the configuration of the policies, policy elements and projects by user 10. Conformance to the system policies may be implemented according to a system conformance process, guided conformance process, and/or manual conformance process. Other manners or implementations of conforming to policies may be included.

For example, in a system conformance process, user 11 may upload, refer, transfer or otherwise enter an interface document or another suitable document, such as an XML document, etc., 12 to the system server 23, and initiate a conformance test. For example, an interface document that is being developed by a user, such as a developer, may be actively or passively transferred, herein referred to as uploaded, to the system server 23, where the interface server may analyze the document for conformance etc. The system server 23 may analyze the document based on, for example, assigned policies, and may return to user 11 typically detailed conformance test results (13), including whether certain policy elements or conformance rules tests ‘passed’ or ‘failed’. The user 11 may be able to amend the document, if necessary, and upload it again to the system server 23 to enable conformance.

For example, in a guided conformance process, user 14 may upload an interface document or another suitable document, such as an XML document 15, to the system server 23, and initiate a conformance test. The system may analyze the document based on, for example, the policies assigned, and guide the user via a set of ‘guiding wizards’ 16 to, for example, collect more information, or get the user's 14 explicit confirmation that user 14 implemented certain policy elements in the XML document 15. Policies may include a set of user actions or wizards, that may, for example, ask the user questions based on elements of documents. For example, if the application of a policy detects a certain type of code, a wizard or other element may cause a query to be sent to the user, to verify that the user has conformed to a certain requirement.

For example, in a semi-automated or manual conformance process, user 17 may upload an interface document or another suitable document, such as an XML document, etc., 18 to the system server 23, and initiate a conformance test. The system server 23 may alert a user 20 that a new manual conformance process was initiated for XML document 18. User 20 may view or download the XML document 19 (which may be identical to 18 with relevant information such as contact information for user 17, project information, project documentation etc. The system server 23 may provide user 20 with information of the applicable policies and the user 20 may be able to review the XML document 19, interact with the user 17 via the system server 23 or via other means (phone, meetings, emails etc.). User 20 may provide user 17 with conformance instructions. User 17 may amend the XML document 18 according to the instructions and upload it again to the system server 23 for final review and approval from user 20.

In the above examples the user may command the system server 23 to automatically or semi-automatically generate a conformed XML document based on an original document and relevant pre-programmed policies. Such a conformed document may be presented to the user, optionally including relevant information, for example, revisions and amendments made by the system server 23, etc. The user may accept the system server conformance suggestions and/or may amend the whole or parts of the document as required. The same user may be involved in any combination of the above three process for, for example, a certain XML document. For example, in case in which certain parts of the policy elements assigned are deterministic and can be analyzed by the system server, other parts of the policy elements may be non-deterministic and may require ‘guidance’ from the user. Further, the specific XML document may have been defined as ‘strategic’ by user 10, may require a manual conformance process regardless of the system server and guided processes. The methods and processes used to analyze documents may differ from the specific examples described above.

In one embodiment of the present invention, user 10 may govern the implementation of policies and conformance. For example, user 10 may initiate escalation processes, resolve exception requests, manage and coordinate processes, encourage and enforce conformance or selective conformance, and reusability, etc. For example, user may initiate escalation by getting specific non-conforming projects or documents authorized, by changing specific policies etc. The system server 23 may be integrated in the current flow of the development process, and may help enable developers early in the analysis and/or design stage to develop fully compliant enterprise class Web services and maintain implementation conformance throughout the implementation, testing, deployment, and maintenance stages.

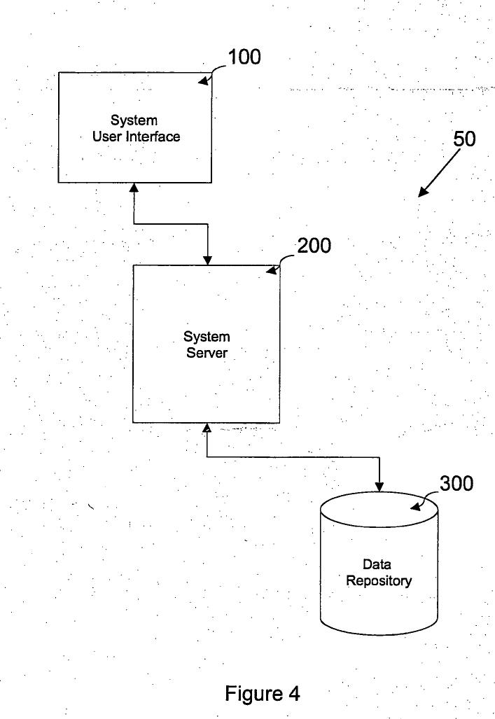

Reference is now made to FIG. 4, which is a high-level schematic illustration of system 50, including a System User Interface 100, for example, on client 51, System server 200, and System Repository 300, for example, in storage server 53, according to an embodiment of the present invention. In alternate embodiments, the functionality of the components may differ, and the functionality may be distributed among other sets of components. User Interface 100 may be responsible for enabling users to access system server 200 in a standard manner, for example, to provide users the same kind of user interface they are using in any other software application. Users of system 50 may be able, through the User Interface 100, to upload, update, review, edit, delete, initiate, etc. any type of information and processes as defined in this document.

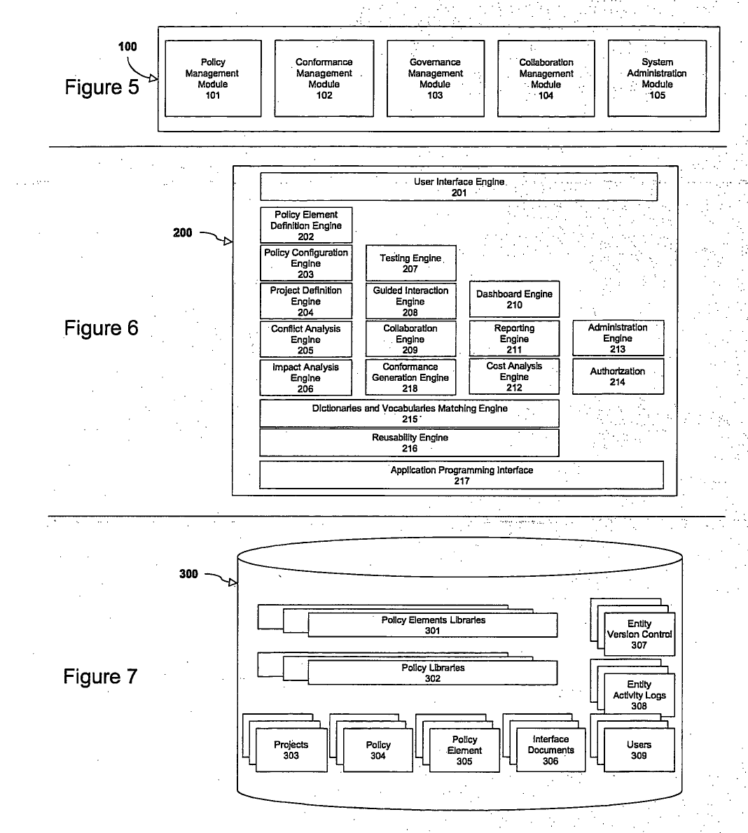

The User Interface 100 may be implemented, for example, as a remote client using, for example, thin or fat client technologies. The User Interface 100 may be, for example, a stand-alone application or may be embedded into third party applications (e.g., as Integrated Development Environments (IDE) etc.). User Interface 100 or User Interface modules (101-105 in FIG. 5), or any combination of them, may reflect many kinds of client implementations. Further, other user interfaces may be used with various embodiments of the present invention. Access to the System Server 200 via the User Interface 100 may be affected over standard computer communication mediums, for example, local area networks and the Internet. Security mechanisms may be applied as required.

The System Server 200 may manage communications with User Interface 100. This may include, for example, receiving information from User Interface 100, storing information such as user inputs, system outputs, transactional information etc. in the System Repository 300, analyzing information according to policies specified in the System Server 200, providing output to User Interface 100, and automating System Processes etc. In other embodiments, other modules may provide such fimctionality, and such functionality may be provided in other manners. System Server 200 may be deployed on any operating system and may be implemented in any technology.

The System Repository 300 may store information gathered via the System Server 200, for example, including user inputs, system outputs, transactional information etc. The System Repository 300 may be deployed on the same machine as System Server 200 or on one or more remote machines. System Repository 300 may reside in a single location or be distributed among multiple repository implementations. These repository implementations may be provided with the system or by any other third party vendor. A single System Server 200 may use any number of System Repositories 300, and any System Repository 300 may provide services to any number of System Servers 200. System Repositories may be implemented via, for example, standard relational databases, XML databases, LDAP servers, File Systems, or any other repository systems. The System Repositories may provide replication functionalities, load balancing, etc.

Reference is now made to FIG. 5, which is a schematic illustration of user interface modules 100, according to an embodiment of the present invention. User Interface Modules 100 may enable users to, for example, manage policies definition and configuration via the Policy Management Module 101; manage conformances of interfaces via the Conformance Management Module 102; and manage governance including, for example, initiating escalations processes, managing exceptions requests, enforcing conformance, encouraging reusability, and direct and manage all tasks necessary to ensure that implementation is done in accordance with policies, time and budget via the Governance Management Module 103. User Interface Modules 100 may also be refereed to herein as Governance Dashboard or Dashboard.

The Governance Management Module 103 may use system engines such as the Collaboration Engine 209, the Dashboard Engine 210, the Reporting Engine 211, the Cost Analysis Engine 212, etc. Through these components the Governance Management Module 103 may enable users to get different views in, for example, push or pull mode, search for specific information about the enterprise interface documents, policies, etc and to generate different reports regarding cost saving, reusability, efficiency, etc. This information may be process related, system interfaces related, exceptions related, cost related, etc.

User Interface Modules 100 may enable users to manage collaboration processes among different System users, for example, to finalize decisions, resolve issues, update knowledge etc. via the Collaboration Management Module 104. User Interface Modules 100 may further enable users to, for example, manage deployment, administration, and maintenance of the System via the System Administration Module 105. Modules (101-105) may be provided as an independent module or bundled together with other modules that are described herein. In alternate embodiments User Interface Modules 100 may provide other or additional functionality.

For example, the User Interface Modules 100 in some implementations of the System may include only the Policy Management Module 101, or may also include the Conformance Management Module 102, or any of the other User Interface Modules (101-105). Furthermore, functionality need not be divided among the modules specifically as shown.

Reference is now made to FIG. 6, which is a detailed schematic illustration of a view of the System Server 200, according to an embodiment of the present invention. System Server 200 may include one or more of: User Interface Engine 201; Policy Element Definition Engine 202; Policy Configuration Engine 203; Project Definition Engine 204; Conflict Analysis Engine 205; Impact Analysis Engine 206; Testing Engine 207; Guided Interaction Engine 208; Collaboration Engine 209; Dashboard Engine 210; Reporting Engine 211; Cost Analysis Engine 212; Administration Engine 213; Authorization Engine 214; Dictionaries and Vocabularies Matching Engine 215; Reusability Engine 216; Application Programming Interface (217); and Conformance Generation Engine 218.

The User Interface Engine 201 may provide the Application Programming Interface (API) for communication with the User Interfaces Modules 100, or any other user interface application that may interact with the System Server 200.

The Policy Element Definition Engine 202 may enable analyzing and translating of Policy Element Definitions that are defined by a user through the User Interface Engine 201, for example, via the Policy Management Module 101 or through a third party vendor implementation. The Policy Element Engine 202 may, for example, check definition validity and provide exceptions back to the User Interface Engine 201 when relevant. The Policy Element Definition Engine 202 may enable storing of relevant information in the System Repository 300.

The Policy Configuration Engine 203 may enable analyzing and translating of Policy Configuration, which may be defined by a user through the User Interface Engine 201, for example, via the Policy Management Module 101 or through a third party vendor implementation. The Policy Configuration Engine 203 may enable checking configuration values validity and providing exceptions back to the User Interface Engine 201 when relevant. The Policy Configuration Engine 203 may also enable storing of relevant information in the System Repository 300.

The Project Definition Engine 204 may enable storing of project, system, platform, operating system, development language, line of business, business function, domain, or other suitable information in the System Repository 300. The Project Definition Engine 204 may also enable checking validity of information and providing exceptions back to the User Interface Engine 201 when relevant.

The Conflict Analysis Engine 205 may enable analyzing conflicts among Policy Elements within a Policy and between Policies within Projects. Both the Policy Configuration Engine 203 and the Project Definition Engine 204 may use the Conflict Analysis Engine 205 for identifying conflicts. The Conflict Analysis Engine 205 may also enable storing relevant information in the System Repository 300.

The Impact Analysis Engine 206 may enable analyzing the impact of changes in Policy Elements, Policies or Projects and exception and other decisions on the interfaces of the relevant Projects. The Impact Analysis Engine 206 may also enable storing relevant information in the System Repository 300.

The Testing Engine 207 may enable constructing a tests tree from relevant Policy Elements for a specific project or other interface document, and executing the Policy Element tests on interface documents. The tests tree may be, for example, a data structure that may optimizes the test results gathered from the Policy Elements, for example, by caching test results, etc., so that, for example, the test engine will not execute the same test more than once. The Testing Engine 207 may enable updating the Policy Elements with the test results and generating a test result report based on the Policy Elements results definition. If the Policy Elements' results return “passed” or “not passed” decision then these results may be provided in the report, otherwise a not deterministic test result may be provided in the test result report. The Testing Engine 207 may also enable storing any relevant information in the System Repository 300. In alternate embodiments, evaluations other than “passed” and “not passed may be used. For example, the system may assign more than two evaluation marks to define proximity of the results by, for example, percentages, weights, predefined conformance levels, etc.

The Guided Interaction Engine 208 may enable translating non-deterministic Policy Element test result script, for example, where compliance tests were not completed due to non-definitive or missing information, into a guided interaction process with the user through the User Interface Engine 201 which interacts with the Policy Management Module 101 or third party vendor user interface implementations. The Guided Interaction Engine 208 may enable updating the test result report generated by the Testing Engine 207 when guided interaction results in a “passed” or “not passed” decision. The Guided Interaction Engine 208 may also enable storing any relevant information in the System Repository 300.

The Collaboration Engine 209 may enable managing collaboration activities among the system users for achieving certain results. For example in cases in which a user does not or can not agree with the Policy Elements that the system requires the user to comply with, or the user does not understand the requirements or would like to define new Policy Element and apply them to certain projects etc. In these cases the user may initiate a collaboration process and get more information, request exceptions, etc. For example, an interface document submitted for a conformance test may fail the test, and in a case where a user disagrees with one or more of the policies as they were applied to the Interface Document submitted, the user may request an exception. Such a request may be distributed to the relevant users via email, systems alerts, IM (instant messaging) alerts, or any other alerting method. The Collaboration Engine 209 may also enable storing any relevant information in the System Repository 300. An example for exception may be: a user uploaded an Interface document that is required to comply with a Policy Element for XML Name Spacing conventions within an enterprise. In the case where the Interface document failed on this policy element, and the user does not want to implement the enterprise namespace policy (e.g., since s/he works with external users that have other namespacing conventions), the user may ask for exception for this specific Interface document. Such an exception may be distributed by the system to the relevant users (that may be architects, or managers for example) via email, systems alerts, IM (instant messaging) alerts, or any other suitable alerting methods.

The Dashboard Engine 210 may enable analyzing, summarizing and personalizing information for presentation through the User Interface Engine 201. The Dashboard Engine 210 may also enable storing any relevant information in the System Repository 300.

The Reporting Engine 211 may enable generating both predefined reports as well as custom query reports of information that is gathered in the System Repository 300.

The Cost Analysis Engine 212 may enable analyzing different cost parameters through the use of the system. Both the Dashboard Engine 210 and the reporting Engine 211 may use the Cost Analysis Engine 212 for presenting Cost related information. The Cost Analysis Engine 212 may also enable storing any relevant information in the System Repository 300.

The Administration Engine 213 may enable configuration, deployment, and maintenance of the System Server 200 as well as the User Interface Modules 100 and the System Repository 300.

The Authorization Engine 214 may enable managing user authorizations in the system including information views, functionalities, roles, etc. The Authorization Engine 214 may communicate with the System Repository 300, which may have relevant User information. The Authorization Engine 214 may also enable storing any relevant information in the System Repository 300.

The Dictionaries and Vocabularies Matching Engine 215 may enable matching dictionaries and vocabularies with the dictionaries and vocabularies which are defined in the System Repository 300. The Testing Engine 207 may use the Dictionaries and Vocabularies Matching Engine 215 for the execution of certain Policy Element tests. The Dictionaries and Vocabularies Matching Engine 215 may also enable storing any relevant information in the System Repository 300.

For example, a policy not to define any new type elements that are not part of the data dictionary may enforce data modeling rules by allowing the creation of application specific XML schemas only from the elements defined in an enterprise data dictionary. Defining data types in a data dictionary may enforce uniform data representation and validation rules. For example, the street element from the address structure may be defined to be no more then 50 characters, or a SSN element may be required to be in the format of XXX-XX-XXXX. Any complex structure that requires such elements may automatically derive all the formatting and validation rules defined for this element from the data dictionary.

```
            For example, a correct sample of the above policy may be:
<xsd:include schemaLocation=“DataDictionary_Elements.xsd”/>
<xsd:element name=“LocalAddress” minOccurs=“0”>
    <xsd:complexType>
    <xsd:sequence>
    <!-- Notice using elements defined in the data dictionary-->
        <xsd:element ref=“Street1” minOccurs=“0”/>
        <xsd:element ref=“City”/>
        <xsd:element ref=“State”/>
        </xsd:sequence>
    </xsd:complexType>
</xsd:element>
            For example, an incorrect sample that defines new elements
instead of using elements from a data dictionary of the above policy may
include:
<xsd:element name=“LocalAddress” minOccurs=“0”>
    <xsd:complexType>
    <xsd:sequence>
    <!-- Notice using elements defined in the data dictionary-->
        <xsd:element name=“Street1” type=“xsd:string” minOccurs=
        “0”/>
        <xsd:element name=“City” type=“xsd:string”/>
        <xsd:element name=“State” type=“xsd:string”/>
    </xsd:sequence>
    </xsd:complexType>
</xsd:element>
```

The Dictionaries and Vocabularies Matching Engine 215 may also provide capabilities including recognizing patterns, resemblance, and proximity among data structures, method signatures, naming conventions, etc. Through the use of these capabilities, for example, the Dictionaries and Vocabularies Matching Engine 215 may, for example, identify similarities between interfaces or parts of them, while designing and implementing new interface documents, and send this information with, for example, its proximity level, to the reusability engine.

The Reusability Engine 216 may enable identifying and analyzing potential reusability opportunities based on events and results from variety of engines or upon initiation of a process by the user. Both the Dashboard Engine 210 and the reporting Engine 211 may use the Reusability Engine 216 for presenting reusability related information. The Reusability Engine 216 may also enable storing any relevant information in the System Repository 300. The Reusability Engine 216 may handle information regarding systems, functionality, life time, dependencies, Quality Of Service (QoS), Service Level Agreement (SLA), Security, Cost, Strategic importance, etc. as well as weights for calculating benefits, proximity etc.

For example, the System Server 200 may collect information about time spent in developing a project (e.g., by recording elapsed time between reporting dates in the system, by gathering information from the users etc.). The System Server 200 may compare this information to initial estimation and budgets as were approved by the enterprise before hand. The system may benchmark such a project with other projects that have the same characteristics (e.g., strategic or not, legacy, number of developers, amount of Web Services etc.). The System Server 200 may receive strategic information from users, for example, information based on the number of potential clients for the project, if the project is budget approved, and other elements that the users may provide.

The Application Programming Interface (217) may enable exposing all or some of the above engines for external integration with third party vendor products as well as future modules of the system, and for consuming third party systems or modules, for example, for repository implementations through standard interfaces such as Java DataBase Connectivity (JDBC), Open DataBase Connectivity (ODBC), XML QUERY Language (Xquery), Lightweight Directory Access Protocol (LDAP), etc.

The Conformance Generation Engine 218 may enable automatically generating conforming XML document based on the Policies and the original document. The generated XN4L document may include only specific changes that were required in order to conform. The Conformance Generation Engine 218 may also generate a report including relevant information of revision and amendments made by the system, etc.

Reference is now made to FIG. 7, which is a detailed schematic illustration of a view of the System Repository 300, which may include a single or multiple repositories, according to an embodiment of the present invention. These repositories may be implemented in variety of standard implementation manners such as relational databases, XML databases, file systems, LDAP servers, WebDav servers etc. Some of these repositories may be implemented within third party products. For example users and authorization information may be stored within any security, authorization, provisioning system, etc. The System Repository 300 may enable storing relevant information regarding the information that is flowing through the system and information regarding the processes within the System Server 200. The System Repository 300 may also enable retrieving information for the different engines within the System Server 200.

According to an embodiment of the present invention, the System Repository 300 may store Policy Elements Libraries 301 which are a set of pre-defined Policy Elements or conformance rules 305 that, for example, came with the system, were added through an upgrade process of the system, were added by third party vendors, were purchased to apply in specific areas as add-ons later along the life cycle of the system, etc. Policy Element Libraries 301 are packages of Policy Elements or conformance rules 305 together and can be referenced as first version of Policy Elements or conformance rules 305 that the user can later on alter. The system may enable to manage through the Administration Engine 213 versions of libraries, addition of libraries and removal of libraries as well as other group operations on all or some of the Policy Elements or conformance rules 305 within a Policy Element Library 301. According to one embodiment, a system may include a database or data collection such as a data repository. The data repository may include for example, a set of policy elements or a policy element library, a set or policies or a policy library, information on interface documents, and other information.

The System Repository 300 may store Policy Libraries 302, which are a set of pre-defined Policies 304 that, for example, came along with the system, were added through an upgrade process of the system, were added by third party vendors, were purchased to apply in specific areas as add-ons later along the life cycle of the system, etc. Policy Libraries 302 may include packages of Policies 304 together and can be referenced as first version of Policies 304 that the user can later on alter. The system may enable management of versions of libraries through the Administration Engine 213, addition of libraries and removal of libraries as well as other group operations on all or some of the Policies 304 within a Policy Library 302.

The System Repository 300 may store information relating to projects, systems, platforms, operating systems, development languages, les of business, business functions, domains, etc. 303, which maintains relevant information regarding an actual development project. A project, system, domain, etc. 303 may contain general information such as name, short description, scope, platforms in use, integrated development environments, participants, stake holders, etc.

A Project, System, Domain, or other suitable grouping 303 may include, for example, multiple sub-projects, sub-systems, sub-domains, or sub-groupings which aggregate information regarding specific systems, development groups or any other user defined hierarchical structure. Policies 304 can be assigned to a Project, System, Domain, etc. 303 and the Project, System, Domain, or group, 303 and all interface or other documents included within or associated with the group typically have to adhere to these Policies 304. Project, System, Domain, etc. 303 may have authorization information that may be handled through the system's Authorization Engine 214 and may be defined as part of the users, privileges, authorization, etc. 309. Project related information may be gathered during various processes within the system and through the governance dashboard 103 a user may view history, evolution, measurements, etc. regarding Projects, Systems, Domains, etc. 303.

The System Repository 300 may store information relating to Policies 304, which may include sets of Policy Elements or conformance rules 305. Policy 304 may be assigned to multiple Projects, Systems, Domains, etc. 303 and it may have multiple versions in the Entity Version Control 307. The System Repository 300 may store information relating to Policy Elements 305, which may define specific requirements or recommendations for an Interface Document 306.

A policy element may, for example, define a specific requirement or recommendation, such as a rule that may be enforceable in system 50. For example, a policy element may ensure that targetNamespace is a default namespace, that clear type names are defined, and that the Enterprise Dictionary is used. A Deterministic Policy Element may determine that interface conformance is to be regulated by the system, for example: use targetNamespace as default namespace. Such policy may be described, for instance, using an XPath expression such as: //*[local-name( )=‘schema’][not@targetNamespace)]. A Non-Deterministic Policy Element may determine that interface conformance is not to be regulated by the system, for example: Clear type names. Other policy elements and types of policy elements may be configured.

An example of a management policy may include a restriction not to implement production services without using a standard management Interface, as defined and enforced in WSDL design time. A sample of a WSDL implementation may be provided. An example of a security policy may include a restriction not to expose services without using a Security Assertions Markup Language (SAML) assertion within a context of Web Server Security, as defined and enforced on SOAP messaging layer. The system may provide samples of correct wire formats. An example of a data modeling policy may include a restriction not to define any new type elements that are not part of the data dictionary. Data modeling rules may be enforced, for example, by allowing creation of application specific XML schemas from the elements defined in an enterprise data dictionary. An example of a policy, as it may be stored in a database or library may be seen with reference to FIG. 21.

Policy Elements 305 may have general information such as name, description, version, etc. They may also have configuration parameters that can be configured, for example, during a Policy configuration process. For example an operator configuration parameter defining whether to “Do” or Do not” do certain operations. Policy Element types may define whether a certain operation is “Required”, “Recommended” or “N/A”. Policy Elements 305 may have internal parameters for internal use during the testing and result generation of the Policy Element 305.

Policy Elements 305 may have self-describing information regarding the Policy Element 305 including advantages, disadvantages, alternatives, conflicting Policy Elements 305 etc. Policy Elements 305 may define required internal parameters for internal use during the testing and result generation of the Policy Element 305. Policy Elements 305 may define required tests from an Interface Document 306 in order to determine whether the document conforms or not to the Policy Element 305.

Policy Elements or conformance rules 305 may define whether test result combinations mean that the tested Interface Document 306 is conforming to the Policy Element 305, hence “Passed”, not conforming to the Policy Element, hence “Not Passed” or that the information is not enough for determining whether the Interface Document 306 is conforming or not, hence requires guided interaction with the user. Policy Elements 305 may define the detailed description of test results including identification of the conformance problem/s through interaction with the Testing Engine 207. Policy Elements 305 may define the interaction, information and choices while guided interaction process with the user occurs. Policy Elements 305 may be, for example, deterministic, such that the interface conformance may be determined by the system (e.g., automatically, possibly using targetNamespace as default namespace), or non-deterministic, where the interface conformance cannot be determined by the system (For example: Clear type names), and may be determined by, for example, a semi-automated process.

The System Repository 300 may store information relating to user defined Documents 306, which may include actual interface documents such as WSDL documents, SOAP documents, XML Schema documents, SLA documents, etc., names, descriptions, size, and information relating to users 309, such as the creator, who may be a user that uploaded the interface, etc., information relating to the Projects, Systems, Domains, etc. 303 these documents are being used in, etc.

The System Repository 300 may store information relating to users, privileges, authorization, etc. 307, which may include descriptions of users, names, roles, groups privileges, authorization etc. User information may be referenced by almost all other information elements that are stored in the System Repository 300. For example, creators, participants, etc.

Users of the system may be able to operate based on their authorization privileges as authorized by the system's Authorization Engine 214.

The System Repository 300 may store activity information relating to any transaction, times, cost, change, etc., which may include information such as timestamps, operation information, users, transaction information, process states etc. The information that is stored and considered to be activity information is any piece of information that might be required in order to “replay” or simulate processes that occurred within the system in an accurate manner.

The System Repository 300 may store Versioning Information relating to any entity defined in the repository 309, which may include information such as dates, version, creator, user that change entity, etc.

General information that might also be stored in the System Repository 300 may include any kind of information that any user of the system might upload or provide, any information that the system might generate, etc. In other embodiments, policy elements may include other information, and this information may be stored in different formats, or among more than one data structure.

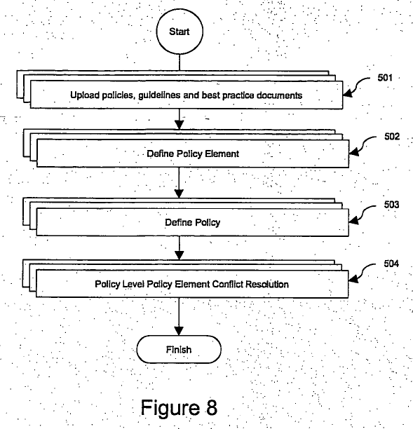

Reference is now made to FIG. 8, which is a flow chart illustrating a Policy Definition Process, according to an embodiment of the present invention. The flowchart depicted in FIG. 8, and the other flowcharts presented herein, provide examples only, and other steps or series of steps may be used for implementing the various aspects of embodiments of the device, system and method of the present invention.

At block 501 a user, for example, a system architect or manager, may upload relevant documents to the system, including, for example, policies, guidelines and best practices documents and manuals, etc. which are relevant to the specific policy definition or set of policy definitions.

At block 502 the user may define a Policy Element through the Policy Management Module 101 and/or a third party vendor user interface that interacts with the User Interface Engine 201. The user may provide the system with information including (but not limited to) the policy element configuration parameters, tests that the user wants the system to conduct for that specific Policy Element, and possible results that the user is interested in receiving from the system if a certain policy element test passed, or did not pass or was not recognized by the system at all.

For example, the user may define a Policy Element that tests whether an XML Schema document is using the “targetNamespace” as the default namespace. In this example details for the Policy Element may be the name of the Policy Element, short description, etc. The user may define configuration parameters such as “Operator” that can, for example, configure the Policy Element so that a test interface document “Do” use “targetNamespace” as the default namespace or “Do not” use “targetNamespace” as the default namespace, etc. The user may define a set of tests that may check whether a test interface document and specific configured parameters are found, have certain values, etc., such as finding the default namespace of an XML Schema document and the “targetNamespace”, and comparing them, etc. The user may also define results whether the Policy Element “Passed”, “Not Passed” or requires guided interaction based on the results of the different tests such as if the “targetNamespace” equals the default namespace, and the Operator is “Do”, then the test interface document may be “Approved” by this Policy Element, etc. Typically, while a Policy Element is directed towards a specific type of document, the system and data structures involved may be used with multiple suitable types of documents.

Such information provided by the user using the Policy Management Module 101, may be analyzed and translated by the Policy Element Definition Engine 202 which may check the definition validity and provide exceptions back to the user through the User Interface Engine 201 and the relevant user interface when relevant. The relevant information may also be stored in the System Repository 300.

At block 503 a Policy Definition may be defined by the user, through the Policy Management Module 101 or a third party vendor user interface that interacts with the User Interface Engine 201. The user may be prompted by the System to provide a Policy name and identify which Policy Elements are to be included in the Policy. The user may also be required to configure the Policy Elements and define different configuration parameters including, for example, whether the Policy Elements are “Required”, “Recommended”, “N/A” (Not applicable) etc. A user may update existing policies, delete policies, replicate policies, rename policies etc. at any time.

At block 504, if required, a user may resolve conflicts between Policy Elements in a given Policy. The server system may prompt the user with potential or existing Policy Elements Conflicts and the user may be prompted to decide how to resolve the conflict. The user may support his/her decision using the Conflict Analysis Engine 205, the Impact Analysis Engine 206 and/or other information as provided by other engines in the System.

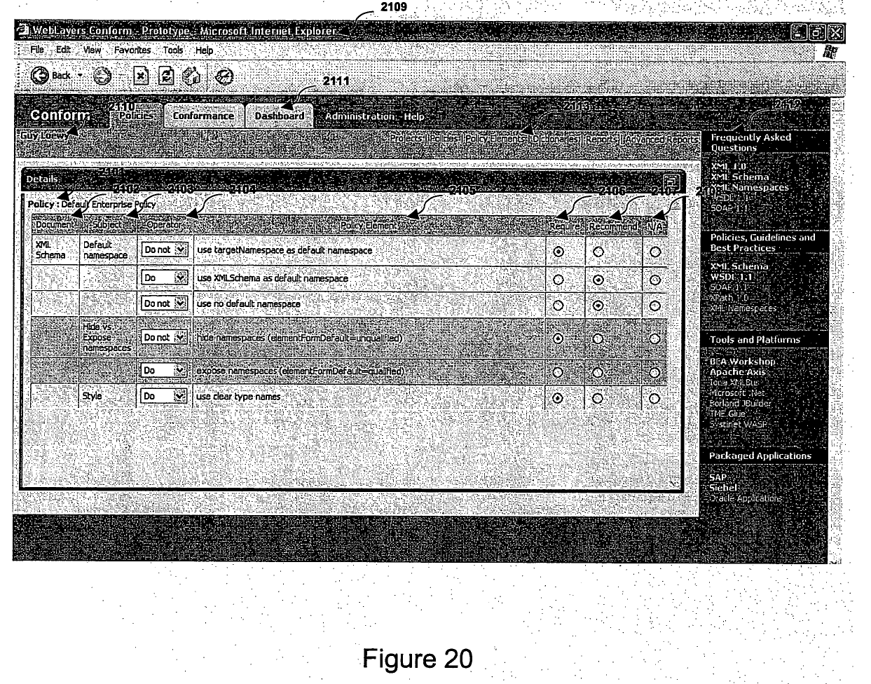

Other steps of series of steps may be used. Any step in the process described in FIG. 8 may be executed independently. The project as defined above is for purposes of example only. A screen shot example of the user interface can be seen in FIGS. 20-22 herein.

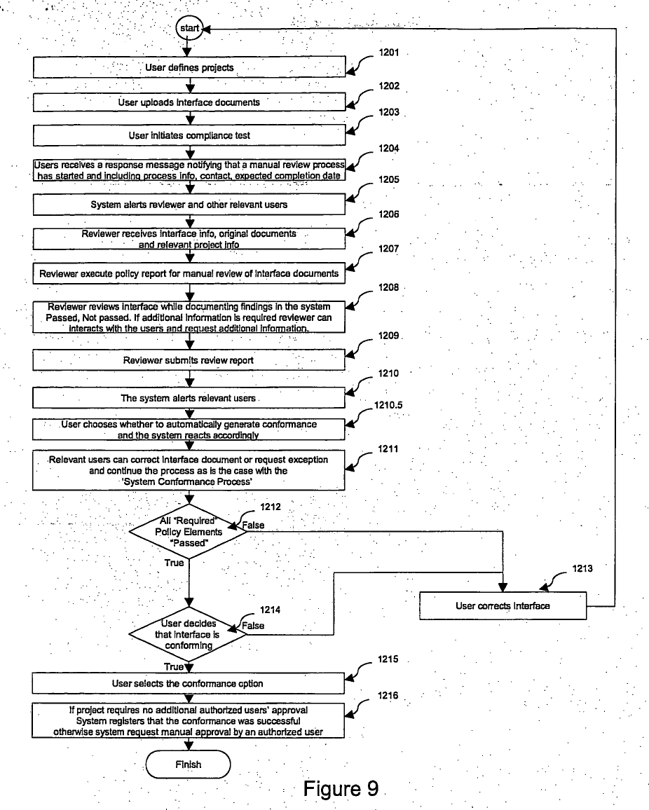

Reference is now made to FIG. 9, which is a flow chart illustrating a manual conformance process, according to an embodiment of the present invention. At block 1201, a user, for example a developer or programmer working on an interface document, application, or project etc., may, for example, define a new project or select an already defined project from a project list through the Conformance Management Module 102. The user may add or update project parameters such as project name, development environment, operating systems, budget, project scope, platforms, description, etc.

At block 1202, once a project is selected the user may upload interface documents to the System Server 200 using the Conformance Management Module 102.

At block 1203, the user may initiate a conformance test by choosing to implement such a test in the Conformance Management Module 102. Based on the type of the project, Policies assigned to the project and Policy Elements, the conformance process may, for example, be handled by the system server in an automatic conformance process, as described in the ‘System Conformance Process’ herein, for example, by another user manually.

At block 1204, since in the described case the conformance process for the specific project may be manual, the system server may notify the user that a manual conformance process was initiated, and may provide the user with information regarding the process, including contact persons, reviewers contact information, expected completion date etc.

At block 1205, the system may also alerts a reviewer user and/or other relevant users such as project manager, etc. based on project information and other relevant information.

At block 1206, the reviewer user, for example, may receive, along with the alert, interface documents information, documents history, the documents themselves, relevant project information, etc.

At block 1207, the reviewer user, for example, may request from the system server to receive a policy conformance report for manual review, which may include a list of Policy Elements that may typically be tested on the specific documents in order to establish conformance.

At block 1208, the reviewer user, for example, may review the documents, read the Policy Element descriptions and explanations, and define which Policy Elements are conformed with and ‘Passed’ and which are not ‘Not Passed’. Along this manual process the reviewer user may interact with the user that uploaded the interface documents, request for additional information and base decisions on that extra information.

At block 1209, once the reviewer user finishes the report he/she may submit the report results through the system server, which may alert relevant users that the report results arrived.

At block 1210.5, the user may command the system to run the automatic Conformance Generation Engine 218, which may automatically generate required changes to the XML document. While an XML document is discussed here and elsewhere, it should be understood that an embodiment of the present invention may work with and analyze documents of varying types.

At block 1211, relevant users may, for example, correct interface documents or request exceptions as described in the ‘System Conformance Process’.

At block 1212, if not all ‘Required’ Policy Elements ‘Passed’ the user may have to correct interface document at block 1213, upload the new version of the document, and optionally restart the whole process.

If all ‘Required’ Policy Elements ‘Passed’ (1212) the user can decide (1214) to keep on working on the interface documents and correct them (1213) or decide that the interface documents are conforming and select the conformance option (1215).

At block 1212, if the project is defined such that no additional authorized users' approval is required the system may register the interface documents as conforming. Otherwise the system may request manual approval that the document is conforming from authorized users. Other steps or series of steps may be used.

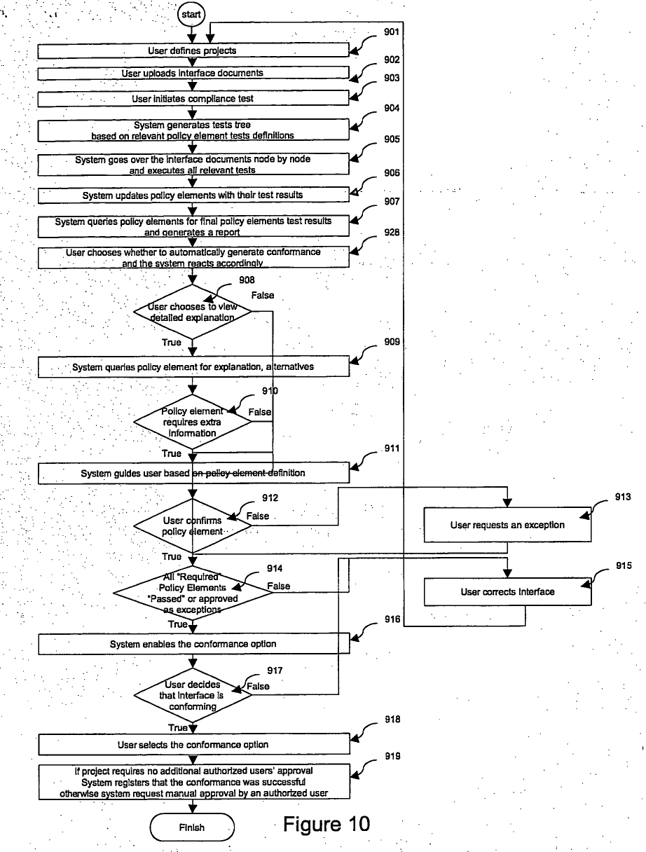

Reference is now made to FIG. 10, which is a flow chart illustrating a system conformance process, according to an embodiment of the present invention. At block 901 a user may, for example, define a new project or choose an already defined project from the project list, through the Conformance Management Module 102 or third party vendor user interface that interacts with the User Interface Engine 201. The user may add or update project parameters such as project name, project scope, platforms, short description, etc.

An example of a basic configuration element is a General Policy Element Definition, which may include, for example, name, subject short description, full description etc. For example, a name could be “Do not use targetNamespace as default namespace”. An example of a Configuration Parameters Definition may include user defined configuration parameters. For example:

<param1 type=“boolean” name=“operator” desc=“defines whether to ‘Do’
or ‘Do not’ do policy element” />

An example of an Internal Parameters Definition may include user defined internal parameters, for example:

<param1 type=“string” name=“targetNamespace” desc=“value of
targetNamespace in test document” />

At block 902, once a project is selected the user may upload interface documents to the System Server 200 using the Conformance Management Module 102, or using a third party vendor user interface that interacts with the User Interface Engine 201.

At block 903, the user may initiate a compliance test by choosing such a test in the Conformance Management Module 102. The User Interface Engine 201 may communicate the conformance request and details to the Testing Engine 207, which may retrieve and construct the relevant information and objects such as relevant Policy Elements from the System Repository 300.

At block 904, the Testing Engine 207 may query the relevant Policy Elements for the required tests, and may construct a tests tree for the specific Project and interface documents. For example, Policy Element tests may take the form of (other suitable forms may be used):

```
<test1 desc=“Check that valid XMLSchema document”>
    if (document.getType( ) == document.XMLSCHEMA)
        test1 = true;
</test1>
<test2 desc=“Check if default namespace equals targetNamespace”>
    if (document.getElement(“xsd:schema”).getAttributeVal(“xmlns”) ==
        document.getElement(“xsd:schema”).getAttributeVal
        (“targetNamespace”))
        test1 = true;
</test2>
```

In the above example, test1 may check that the interface document is of type XML Schema, and test2 may check that the default namespace equals the targetnamespace defined by the targetnamespace attribute value. Tests may be implemented in other ways that may be based on other suitable technologies, techniques, etc. in order to achieve similar testing capabilities. For example, using XPath expressions to identify elements, attributes, values, etc. or other suitable ways may be used.

At block 905, the Testing Engine 207 may execute some or all of the tests in the tests tree while going node by node over the interface document. At block 906 the system server may update the results back to the relevant Policy Elements. In alternate embodiments, a test tree or similar data structure need not be used to organize or perform tests or apply rules or policy elements.

At block 907, the Testing Engine 207 may query the Policy Elements for the conformance test results, and may construct a test result report based on the Policy Elements results definition. These Policy Elements may be implemented, for example, as an object in an object oriented programming language. Objects may be queried via their methods, as stored in a repository, using standard query interfaces such as SQL, XQuery, etc. Other methods of implementing policies or other rules may be used. Policy Element tests may be implemented using external rule engine tools, coded, XPath expressions, and/or queries of a database stored procedure, etc. For example Policy Element test evaluation may take the form of (other suitable forms may be used):

```
<Result1>
    if (test1.passed( ) && test2.passed( ) && operator.isDo( ))
        return(document.PASSED)
    else
        return(document.FAILED)
</Result1>
<Result2>
    if (test1.passed( ) && test2.unresolved( ) && operator.isDo( ))
            Center.messageToUser(“Couldn't find whether default
                    namespace equals to targetNamespace”);
            response = Center.getUserResponse(“Are they equal?”);
            if (response == true)
                return(document.PASSED)
            else
                return(document.FAILED)
    else
        return(document.FAILED)
</Result2>
```

Results may be implemented in other ways that may be based on other technologies, techniques, metrics etc. For example, instead of using “Passed” and “Not passed” marks other metrics such as 1-10, percentage of conformance marks, etc. may be used. If the Policy Elements' results return a “passed” or “not passed” decision, these results may be provided in the report. In other cases a non-deterministic test result may be provided in the test result report. The Testing Engine 207 may also enable updating and storing any relevant information in the System Repository 300. The test result report may be sent back from the Testing Engine 207 through the User Interface Engine 201 to the user interface Conformance Management Module 102.

At block 928 the user may command the system server to run the automatic Conformance Generation Engine 218, which may automatically generate required changes to the XML document.

At block 908, the user may choose whether to view a detailed explanation of any specific test result in the report.

At block 909, if the user chose to view detailed explanations, the Testing Engine 207 may query the Policy Element and send the detailed explanation to the user via the User Interface Engine 201, the third party vendor user interface, and/or the Conformance Management Module 102.

At block 910, if the Policy Element did not define a test result interaction with the user may be required. At block 911, the Testing Engine 207 may use the Guided Interaction Engine 208 in order to interact with the user and guide him/her to finish the test and decide whether the test result “Passed” or “Not Passed”, and optionally provide a detailed explanation. A detailed explanation of this process is described separately herein.

At block 912, based on these explanations, the user may decide whether to “Confirm” that he/she will correct the interface documents, or raise an “Exception” to the Policy Element.

At block 913, in the case where the user chose to raise an “Exception” for a Policy Element, an exception request process may be initiated with the relevant users of the system server, which may be managed by the Collaboration Engine 209. A detailed explanation of this process is described in the “Exception Governance Process” herein.

At block 914, if not all Policy Elements that were configured as required “Passed” or were approved to be exceptions, which means that there is at least one Policy Element which is required and “Not Passed”, the user may have to correct the interface documents, at block 915, or negotiate requirements through a collaboration process. In any case the user may have to start the process over in order for the system server to approve the conformance of these interface documents.

At block 916, if all Policy Elements that were configured as requirements “Passed” or were approved as exceptions at block 914, the Conformance Management Module 102 may enable the conformance option at block 916 for the user.

At block 917, the user may decide whether to approve the conformance of the interface documents or not by choosing the conformance approval option at block 918. If the user decides that the interface documents still need adjustments, for example for correcting interface documents based on Policy Elements that are configured as recommendations, the user may correct the interface documents at block 915 and start the process from the beginning.

At block 919, if the user chose the conformance option at block 918, the system server may check if other authorized users are required in order to approve the conformance process ended. If no other users required the system may store the relevant information in the System Repository 300 and the process may be ended. The system server may request an authorized to approve the data before storing it.

At any stage during the process the user may start a collaboration process to communicate with other users of the system server and get assistance. At any stage during the process the user may, for example, stop working on a specific policy element test result, work on other policy elements' test results and return to that specific policy element later on and continue working from the same place. For example, choosing to view a detailed explanation for any Policy Element test result at block 908 from the report generated at block 907 may start another process, while a previous process state may be stored by the Testing Engine 207 in the System Repository 300. At any time the user may return to work on the previous Policy Element from the same state that the user left it. Alternatively the user may start working on that Policy Element test result from the beginning.

During the System Conformance Process there may be cases in which Policy Elements may not define whether a test result “Passed” or “Not Passed”, and which may require extra information from the user at block 910. In such cases the Testing Engine 207 may, for example, use the Guided Interaction Engine 208 in order to interact with the user and guide him/her in order to finish the test and decide whether the test result “Passed” or “Not Passed” (911). In a case where the user is queried and responds to the query, the system server may accept the response and, based on the response, may generate a pass or fail for a relevant rule. For example, the user may answer a question that may look like: “The system could not find the default namespace. Is it the targetNamespace?”, and the user may have to answer YES or NO. The user response may be the basis for the system definition whether the document is in conformance or not.

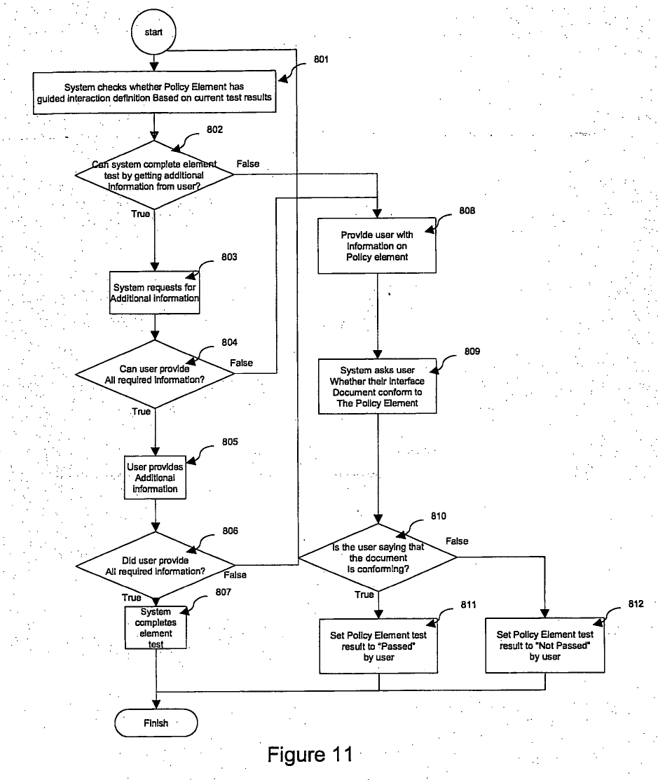

Reference is now made to FIG. 11, which is a flow chart illustrating a guided conformance process, according to an embodiment of the present invention. At block 801 the Guided Interaction Engine 208 may check whether the Policy Element has a guided interaction process defined based on current test results.

At block 802, if the Policy Element could not supply the Guided Interaction Engine 208 with guided interaction definition the user may manually “Pass” or “Not Pass” the conformance of the interface document to the Policy Element. In such a case, at block 808, the system server may provide the user with relevant Policy Element information.

At block 809, the system server may prompt the user to choose whether the interface document conforms or not to the Policy Element 809. At block 810, if the user determines that the interface document conforms to the Policy Element 810 the Policy Element test result may be set to “Passed” by the user at block 811, and the process may end. Otherwise the Policy Element test result may be set to “Not Passed” by the user at block 812 and the process may end.

At block 802, if the Policy Element could supply the Guided Interaction Engine 208 with guided interaction definition, the Guided Interaction Engine 208 may prompt the user to provide additional information based on the guided interaction definition from the Policy Element at block 803.

At block 804, if the user cannot provide the information required by the system server through the guided interaction, the system server may continue as if the Policy Element could not supply the Guided Interaction Engine 208 with guided interaction definition (block 802), and the system may provide the user with relevant Policy Element information (808), and proceed as described above towards manual decision by the user. At block 805, if the user can provide the information at block 804, the user may provide the additional information.

At block 806, the Guided Interaction Engine 208 may check with the Policy Element if it requires extra information (block 806). If the information received up until this stage is not enough, the system server may restart the process with current information from block 801.

If the Policy Element has enough information to decide whether interface document conforms to the Policy Element or not at block 806, the Policy Element may decide whether the conformance of the interface document to the Policy element “Passed” or “Not Passed” (807), and the result may be updated by the Guided Interaction Engine 208 to the System Repository 300. The process may continue by the Testing Engine 207 along the System Conformance Process.

At any stage during the process the user may start a collaboration process to communicate with other users of the system and get assistance. At any stage during the process the user may stop working on a specific process, work on other processes and return to a previous process at a later time.

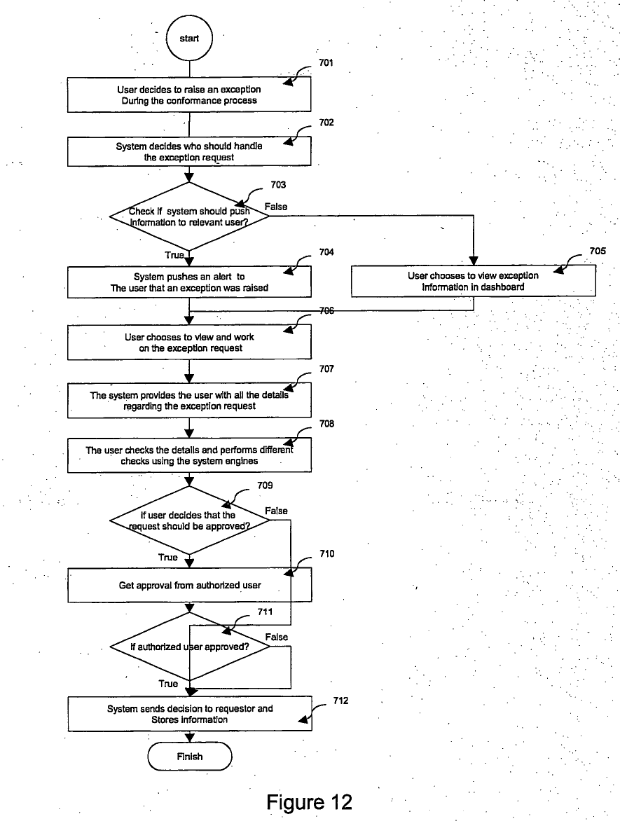

Reference is now made to FIG. 12, which is a flow chart illustrating an Exception Governance process, according to an embodiment of the present invention. At block 701, at any time during the conformance process, a user, such as an interface document developer, may raise an exception and/or get a view of exception requests from different users of the system regarding different projects and Policy Elements. For example, if an interface document has been checked for conformance against a particular policy element and has not been in conformance with the particular policy element, the developer of the interface document may request an exception, to have an authoritative user, such as an architect, grant an exception. In this way the interface document may be passed by the system, thereby being defined as in conformance with the system policies, possibly without being in conformance with the particular policy element.

At block 702, based on exception details such as project, requestor, interface document, etc. the system server may decide which relevant user(s) may handle the exception request. At block 703, based on the additional information regarding the user profiles, the system server may decide whether the information is to be pushed, and if it is to be pushed, through which means (e.g., eMail, SMS, etc.).

At block 704, the user may receive alerts that are pushed to him/her once an exception request was opened. An example of an exception request that might be initiated is described as part of the “System Conformance Process” described at block 913 above. At block 705, the user may choose to view exception information directly on the user's Dashboard.

At block 706, whether the user receives an alert from the system (block 704) or chooses a specific exception (block 705) from the Governance Management Module 103 or dashboard, the user may have to choose to handle a specific exception request and open it for review.

At block 707, the Governance Management Module 103 may provide the. user with the details regarding the exception request, which may enable the user to verify the details. At block 708, the user may perform different tests using the different system engines such as, but not limited to, the Impact Analysis Engine 206, the Conflict Analysis Engine 205, the Cost Analysis Engine 212, the Reusability Engine 216, etc. and optionally to notify other users of the system server that this exception request may impact on in order to get their views.

At block 709, if the user decides that the request is not to be approved, based on the detailed information and the test results, the system server may send the decision to reject the exception request (712) and store the decision information in the System Repository 300. In such a case, an interface document developer may be required to further change the interface document in order to be in order for conformance to policy.

At block 710, if the user decides that such request is to be approved, based on the detailed information and the test results, the system server may require an authorized user based on the Authorization Engine 214 to approve the acceptance of the exception request (710).

At block 711, once an authorized user approves or rejects the exception request, the decision may be sent by the system server to the user that requested the exception at block 712, and the decision information may be stored in the System Repository 300.

In any case in which the user that requested the exception does not agree with the decision, the user may request a higher authority to reevaluate the exception request.

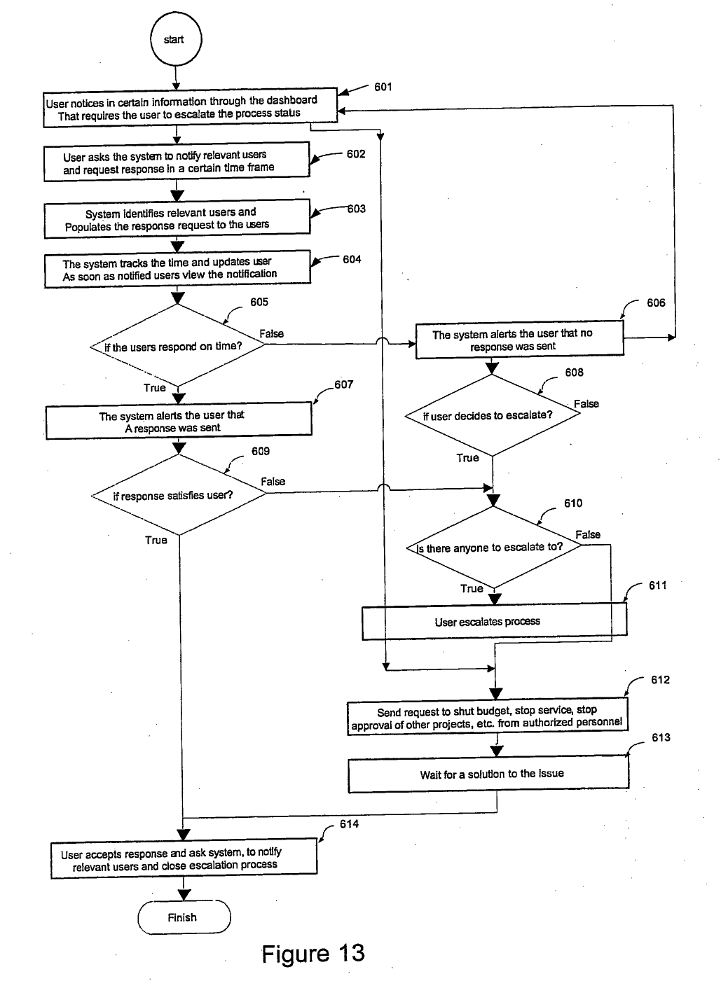

Reference is now made to FIG. 13, which is a flow chart illustrating an Escalation Governance Process, according to an embodiment of the present invention. At block 601, the Escalation Governance Process may be initiated by authorized users based on the Authorization Engine 214, for example, at any time the user notices information that requires the user to escalate the process. The user might base the decision to initiate an escalation process on information from a view of over due tasks, tasks that are supposed to be finished soon, tasks in the works, etc. from the Governance Management Module or Dashboard 103, or alerts that are pushed once a certain event had occurred.

At block 602, the user may use, for example, the Governance Management Module 103 to request from the system server to notify the relevant users about the escalation, and request response within a certain time frame. At block 603, the system may identify the relevant users and may distribute the request for information from the user to these relevant users.

At block 604, the system may track the time and status of the request(s) and may update the user. For example once a user reads the request the user may be notified that the request was read. At block 605, if the users respond within the time frame that the user defined, the system may alert the user that a response has arrived at block 607.

At block 609, the user may accept (be satisfied with) the response(s), at block 614 may ask of the system server to notify the relevant users that the escalation process has finished, and to close the escalation process.

At block 606, if the users do not respond on time the system server may alert the user that no response was sent. At block 608 the user may have to decide whether to escalate (block 608) or try again to receive a response by resending a notification to users (block 602).

At block 610, in the case where the response (block 609) is not satisfying or the case where the user decides to escalate (block 608), the user may check if there is anyone to escalate the process too. At block 611, in the case where there is someone the user can escalate the process to, the user may escalate the process, and may asks the system to notify relevant users (block 602).

At block 612, in the case where there is no one to escalate the process to (block 610), the user may send a request to enforce governance. Enforcing governance may include, for example, to request to shut the budget, stop services, stop approval for other projects, etc.

At block 613, as a result of the enforcement the user may wait for the process to take effect and receive a response. At block 614, the system may notify the relevant users that the escalation process has finished and remove the escalation status.

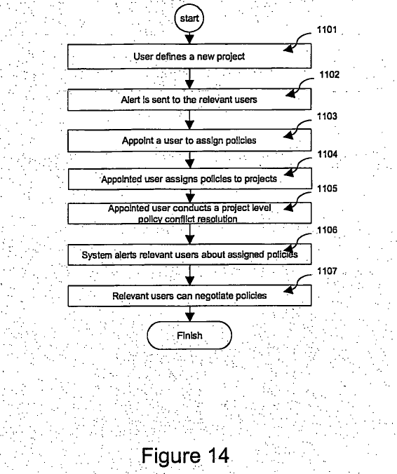

Reference is now made to FIG. 14, which is a flow chart illustrating a policy assignment process, according to an embodiment of the present invention. The system server may contain multiple policies and multiple rules or policy elements. The system may relate to or be used to govern multiple different interface documents based on the same or different policies. A user, such as a manager, may assign selected policies to interface documents, projects, systems, platforms, operating systems, development languages, lines of business, business functions, domains, or other suitable groups, the selected policies being a subset of policies from a set of policies, each policy including a set of conformance rules. Each of the selected policies may be applied to interface documents that relate to or are included within said the groupings, projects, systems, platforms, operating systems, development languages, lines of business, business functions, domains, etc.

At block 1101, a user, for example a manager, may, for example, define a new group such as a project, system, domain, etc. or choose an already defined project, system, domain, etc. from the system repository through for example the Conformance Management Module 102. The user may add or update project, system, domain, etc. parameters such as name, scope, short description, etc. Such information may be updated to the Project Definition Engine 204.

At block 1102, the system server may alert other relevant users, for example, developers, in cases where a new project was created by any user of the system as defined in block 1101. At block 1103, an authorized user may be appointed by the relevant users to assign policies for the project. Other relevant users may also assign policies to the project.

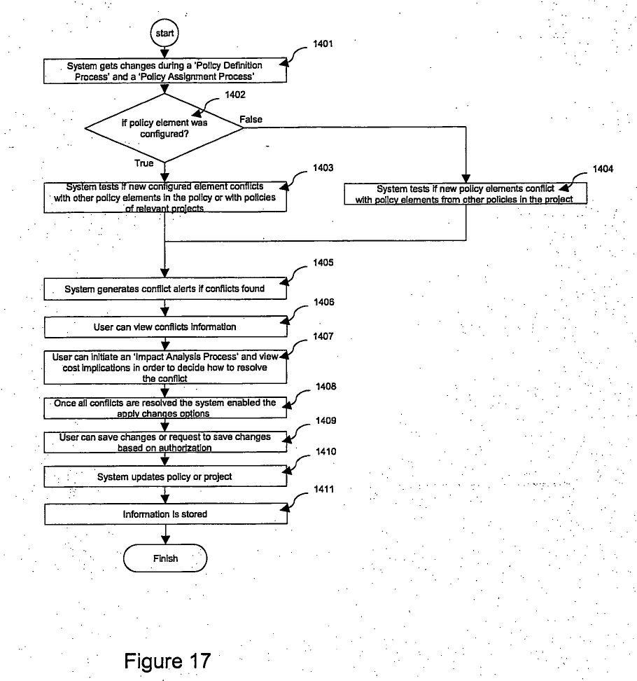

At block 1104, an authorized user may assign policies to projects in step through the Policy Management Module 101. The authorized user may be prompted by the system server with a list of Policies and Projects as defined in the system server and the user may assign Policies to Projects. At block 1105, the System server may initiate a ‘Conflict Analysis Process’ (for example as described in detail herein, and in FIG. 17) and may not enable application of the assignment unless all conflicts are resolved.

A user may initiate the ‘Impact Analysis Process’ at any stage during the above process. Once the user decided on the policies and resolved all conflicts, the user may apply a policy assignment, or request from an authorized user to apply the assignment. At block 1106, the system may alert relevant users that policies were assigned to the project. At block 1107 the relevant users may be enabled to negotiate these policies, and request for exceptions or changes etc.

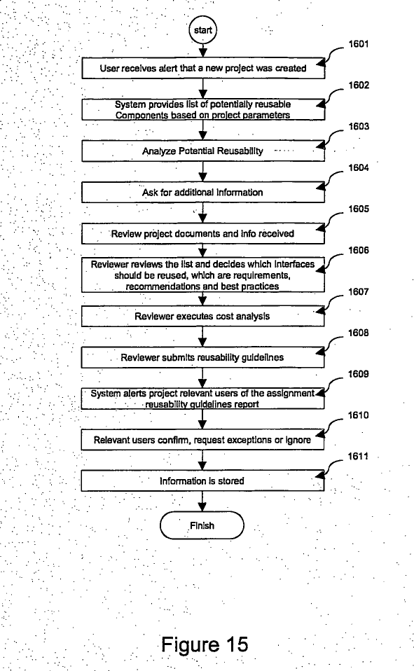

Reference is now made to FIG. 15, which is a flow chart illustrating a reusability governance process, according to an embodiment of the present invention. At block 1601, any time a new project is created in the system in any of the different processes described herein, relevant users may receive an alert notifying them that a new project has been created.

At block 1602, the system may provide the user with a list of potentially reusable interfaces components based on the project information and any additional information the project might already have in the system. At block 1603, the user may analyze potential reusability based on the provided list and project information. At block 1604, the user may request additional information from the relevant users in order to better understand the potential reusability.

At block 1605, a user, for example, a reviewer, may review relevant information, for example, including additional information from users. At block 1606, the user may decide which interfaces, dictionaries, components, etc. may be reused, and whether these are requirements, recommendations or best practices etc.

At block 1607, the user may execute a cost analysis and associate cost and cost savings for each reusability requirement, recommendation, and best practice, or for a project as a whole. At block 1608, the user may submit final reusability guidelines with cost parameters associated through the system server.

At block 1609, the system server may alert relevant users of the assignment of reusability guidelines to the project. At block 1610 these relevant users may confirm the guidelines, request exceptions, or ignore the guidelines etc., based on system server pre-defined policies and configurations.

At block 1611, information may be stored and optionally used by the system server and the relevant users to approve conformance later on in other processes in the system server.

According to one embodiment of the present invention, a Reuse process may be implemented by a user, for example, in which the system may analyze the potential reuse cases based on current resources. A user may upload an Interface to the system and, for example, initiate a Conformance Test or directly request to receive a potential reusability report. The system may analyze the interfaces structure, components, vocabulary etc. and execute a search for similar parameters in the Interfaces repositories (of the system server, or external repositories). Based on the information provided the system may alert the user of potential reusable interfaces including proximity level information etc., and the user may select whether to use or ignore system recommendations. The user may set up a filter for reusability alerts, for example that only reusable elements with a proximity of 95% will appear as alerts, or the user may configure the system server to filter out to any other user in the system or any alert with a proximity lower than, for example, 75%.

The Parameters that may be analyzed by the system server or the user, for example, to detect potential reusability, define its proximity and conclude whether it's a requirement, recommendation or best practice, may include information such as the project in which that interface reside, the system on which this interfaces is operated, interoperability between the project and the potentially reusable interfaces, life-span of the potentially reusable interfaces, performance and load balancing issues, whether the interface is internal or external, security issues, data formats, cost of the development of the interface, whether that interface was reused before, how long and how difficult was it to reuse the interface, whether it was declared as strategic or not, whether there is a decision that this interface “must” be reused etc. All the above parameters and others may be configured by the system server including weights for parameters that may enable the system server or the user to generate a proximity and guideline results.

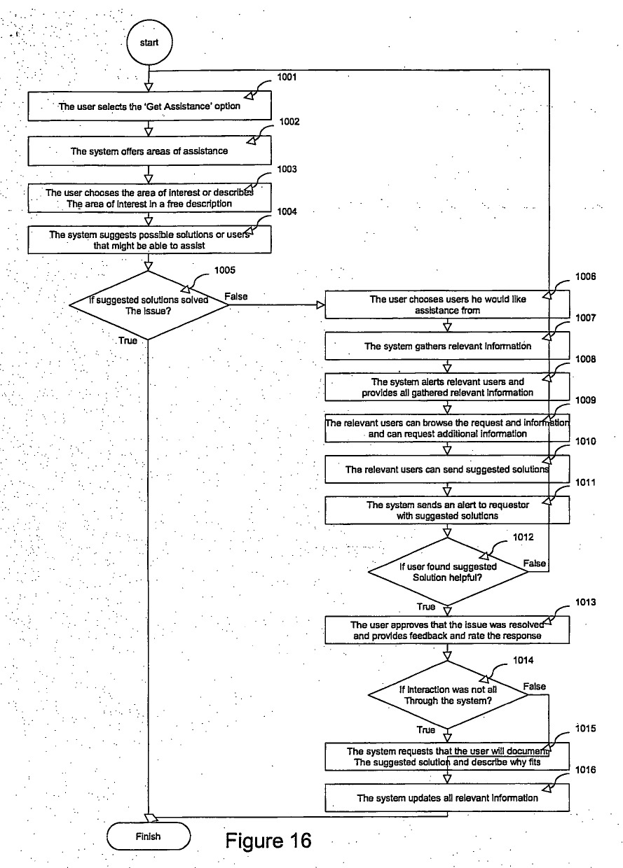

Reference is now made to FIG. 16, which is a flow chart illustrating an assistance process, according to an embodiment of the present invention. The Assistance Process may be initiated by any user of the system at any step along the system's processes from any screen of the User Interface Modules 100. At block 1001, the user may select the assistance option from the screen of the User Interface Modules 100 that the user is working on and would like to get assistance with.

At block 1002, the system server may offer to the user several areas of assistance or an open area description. At block 1003, based on the suggested areas, the user may decide whether one of the areas is the area of interest, or may write an open description of the assistance request. At block 1004, the system server may suggest solutions for issues in the selected area or potential people that the user can choose from, based on the area the user selected, or from an open list of people.

At block 1005, if the user can close the assistance request based on the suggested solutions, the information may be updated in the System Repository 300, at block 1016, and the assistance request may be closed by the system.

In the case where the user chooses the relevant people for assistance (block 1006), the system server may gather the relevant information at block 1007 based on the state the user is in and/or the area of assistance request. At block 1008 the system server may alert the relevant people with the information.

At block 1009, the users that receive the alert may browse the information regarding the assistance request or request for additional information from the requestor. The users may continue the process through the system server or directly through other means, for example, direct email, phone, etc.

At block 1010, if the relevant users believe they can assist the requestor they may suggest solutions that, at block 1011 the system may send back to the requestor as an alert. At block 1012, if the suggested solution does not satisfy the requestor the user may redefine the assistance request and request additional assistance (block 1002). At block 1013, if the suggested solution does satisfy the requester, the user may confirm that the issue was resolved and may provide feedback, for example, by rating the response.

At block 1014, if the assistance process was managed directly between the user and the assisting people and not through the system, the system server may require the user to provide, at block 1015, the knowledge describing the suggested solution. At block 1016, if the suggested solution does not satisfy the requester, the system server may update the system repository 300 with the knowledge about the assistance and the solution and close the assistance request.

During the process the system server may store the relevant information in the System Repository 300, which may enable users to view, for example, in the Governance Management Module 103, the status of the assistance request, whether the requests were read, by whom, history, etc.

Reference is now made to FIG. 17, which is a flow chart illustrating a conflict analysis process, according to an embodiment of the present invention. The Conflict Analysis Process may use the Conflict Analysis engine 205 to perform all system server functions in the following process unless specifically mentioned otherwise. At block 1401, when a change in Policy Element configuration or Policy assignment is done in the system, or when a new policy element is added, the Conflict Analysis Engine 205 may be notified by the system server. For example in the Policy Definition Process once a user configures Policy Elements (503), the system server may activate the Conflict Analysis Engine 205 in order to try and assist in resolving conflicts (504).

At block 1402, in cases where the Policy Element was configured, the Conflict Analysis Engine 205 tests, at block 1403 whether the new configuration conflicts with other Policy Elements that are defined in the policy, or with other policies in relevant projects. At block 1402, in cases where the Policy Element was not configured, the Conflict Analysis Engine 205 may test whether a new assigned policy conflicts with other policies in the project. For example, in a Policy Assignment Process where one user assigns policies to a project (1104) there might be conflict that may require resolving (1105).

At block 1405, in any case where the Conflict Analysis Engine 205 encounters conflicts, the system server may generate conflict alerts that may be shown to the users. The ‘Apply Changes’ option may become disabled. At block 1406, the user may view detailed conflict information including but not limited to conflicting Policy Elements, recommendations for solutions, etc.

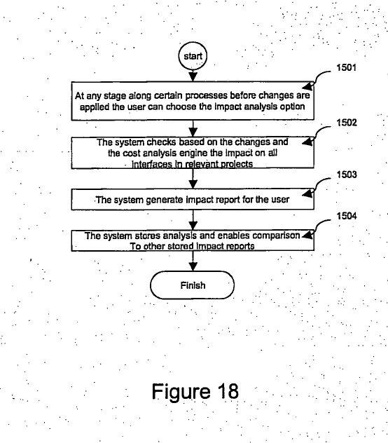

At block 1407, the user may initiate an ‘Impact Analysis Process’. An example of an impact analysis process, as may be seen with reference to FIG. 18, may be implemented in order to better understand the implications of solving conflicts in one way or another.

At block 1408, optionally after all conflicts have been resolved by the user, the system server may enable the ‘Apply Changes’ options. At block 1409, such an option may enable the user to save changes or request to save changes based on authorization.

At block 1410, the system server may update the changes to the Policy or Project. At block 1411 relevant information may be stored in the System Repository 300.

Reference is now made to FIG. 18, which is a flow chart illustrating an impact analysis process, according to an embodiment of the present invention. The impact analysis process may utilize the Impact Analysis engine 206 to perform system functions in the following process, unless specifically mentioned otherwise. At block 1501, any time a change in Policy Element configuration or Policy assignment is done and any time a user requests for exceptions or other changes that might have impact on other projects, interfaces, etc., the user may initiate the impact analysis option.

At block 1502, based on the suggested changes, the system server may perform an impact analysis to check the impact on other projects, interface documents, time, cost, etc., for example, using the Cost Analysis Engine 212. For example, the system server may analyze a plurality of relevant interface documents stored in the system, to, for example, simulate the reaction of such documents to the policy changes. An impact analysis may be performed at any time. At block 1503, the system server may generate an impact report for the user which may cover some or all of the aspects of the impact on different projects, such as but not limited to implementation time, required resources, cost etc.

At block 1504, the system may store the analysis data and may enable the user to compare the analysis with other impact analysis reports, for example, side by side. In this way the user may try alternatives, compare different constellations of suggested solutions, and optimize the chosen solution etc.

For example while checking an exception request in an Exception Governance Process, the user may compare the implications of the exception request on other systems, potential future integration projects, and the specific system etc. Furthermore, the user may try several alternatives of implementing based on the Policy Element, and may compare the implications to granting the exception to the user. In this way the user may also justify a decision to reject or except exception requests for supervisors if required in cases of appeal, etc.

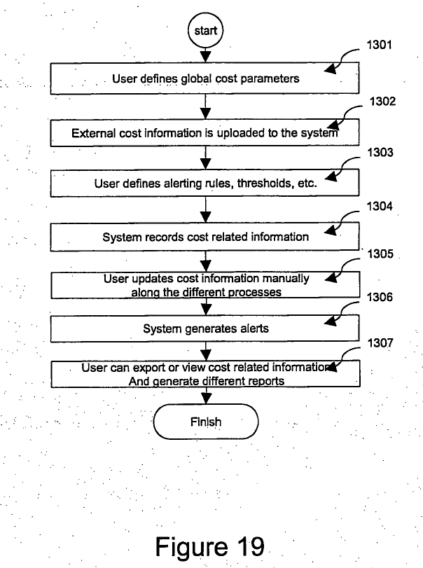

Reference is now made to FIG. 19, which is a flow chart illustrating a cost analysis configuration process, according to an embodiment of the present invention. The Cost Analysis Configuration Process may utilize the Cost Analysis engine 212 to perform system functions in the following process, unless specifically mentioned otherwise. At block 1301, the user may define global cost parameters for the system including but not limited to, price per hour, price per interface, importance, strategically/tactical, life span, number of expected transactions, number of potential reusability opportunities, etc.

At block 1302, the Cost Analysis Engine may also base cost calculations on external cost information from other systems that might be uploaded to the system, for example financial systems, project management systems, etc.

At block 1303, the user may also define alerting rules, thresholds, etc. to the engine in order for the system server to govern budgets, suggest resources, escalate processes based on performance, etc. For example the system server may notify users that the time they are spending on a certain project may be relatively minimal, that the project's cost may be substantially less than other systems, that such a project is less strategic, that too much time is being invested, that the process may need to be escalated etc., according to pre-defined policies.

At block 1304, during operation, the system server may record information relating to performance, time, investment, etc. For example, users may assist in calculating and later on forecasting time, resources and cost of different projects. This information may also be viewed through the Governance Dashboard and may be analyzed in order to optimize performance and provide information on cost savings.

At block 1305, during the different processes described above, the system server may require the different users to supply cost related information that the system cannot record or that the system cannot otherwise collect. For example, total development cost, total development time, total resources investing in the development, design, QA, etc. This information may be analyzed and validated based on the information the system gathers on its own and may provide a wider view of the investment that is done in any specific interface.

At block 1301, based on the above information the system may generate alerts to the relevant users notifying on budgets that are being exceeded, changes that might result in delays or getting over the budget, etc. At any point in the above process the user may view cost related information, generate different reports and export cost information, etc. The system server may also analyze cost relating to SLA, QoS and other parameters that may be added to the system server's calculation and decision weights. The system may calculate marks for efficiency based on comparison with equivalent projects cost information and weights the user can configure.

The various methods and processes described herein may be executed by, for example, CPU 55, memory 56, storage 57, client 51, and storage server 53, and by, for example, associated software or other executable code, but may be performed by other suitable hardware and/or software modules. Additionally, elements from one type of process may be used with other processes, in any combination.

Reference is now made to FIGS. 20-26, which are examples of screenshots according to embodiments of the present invention. The screen shots provided in FIGS. 20-26 are examples for a thin-client (web interface) in which the user is using a standard off-the-shelf web browser in order to access and interact with the system. In this example is using a standard Microsoft Internet Explorer (2109). Other client interfaces may be used. In screenshots provided (FIGS. 20-26) standard web application navigation and browsing techniques may be used, including clicking on links in order to view more information, initiate processes, and mark results etc. The various screenshots shown provide examples only. Other information and functionality may be provided to the user, and other methods of presenting information may be provided. The information presented and the functions available for use in all the screenshots in FIGS. 20-26 may be based on user authorization.

FIG. 20 illustrates general additional capabilities that may be relevant to other screenshots. System server may provide the user with the user login name (2110), and may enable the user to switch between work modes (2111) at any time, for example, to work on definitions of policies and conformance, viewing a dashboard, administration, or viewing help files etc. A user may also be able to access knowledge (2112) including Frequently Asked Questions on variety of relevant topics, Policies, Guidelines and Best Practices, Tools and Platforms information, Packaged Applications, and any other information that was pre-configured to be available to the user in that area. The system server may also provide additional navigation links (2113) that are relevant to the current function that the user is using. In FIG. 20 for example, the user may switch between Projects definition, Policies, Policy Elements, Dictionaries, Reports and Advanced reports.

FIG. 20 is an example representation of policy configuration screen, according to one embodiment of the present invention. The policy configuration screen may include, for example, Policy Name (2101), which is the name of the policy which is being defined by the user. Policy elements for configuration may include: Interface Document (2102)—the type of document a specific Policy Element applies to, e.g., XML Schema, WSDL document, etc.; Policy Element Subject (2103)—the field and subject the Policy Element is dealing with, for example, Default Namespace, Style, etc.; Policy Operator (2104)—the operator that may be applied to the Policy Element, for example “Do” if you would like the user to do something or “Do not” in case you would like the user not do something; Policy Element short description (2105)—the name and short description of the Policy Element; and Importance level—the level of importance of a Policy Element within the Policy. “Required” (2106) is a necessary Policy Element; “Recommended” is a “nice to have” policy element; and “N/A” (Not applicable) is a policy element that is not applicable.

FIG. 21 is an example representation of a policy element definition screen according to one embodiment of the present invention. The policy element definition screen may include, for example, a Policy Element Name, which is the name of the policy element that is being defined (2201). A Configuration Definition Element may be provided, which relates to the area in which the user defines configuration parameters. The configuration parameters may be used by the user during a Policy Configuration (2202). An Internal Definition Element may include the area in which the user defines internal parameters. The internal parameters may be used internally in the Policy Element definition of tests and results (2203). For example, an Internal Parameters Definition may include, for example, a ‘targetNamespace’ parameter, which may be used to store the value of the targetNamespace from a document, and enable comparison to that value during a test. A Tests Definition Element (2204) may be provided that includes, for example, the area in which the user defines tests for checking conformance of a test document to the Policy Element. The tests may be executed by, for example, the Testing Engine 207 or another suitable module or set of modules during the System Conformance Process. A Results Definition Element (2205) may be provided, which may include the area in which the user defines whether a document “Passed”, “Not Passed” or that additional information is required. The different results may be defined based on the different combinations of the test results that were executed by, for example, the Testing Engine 207.

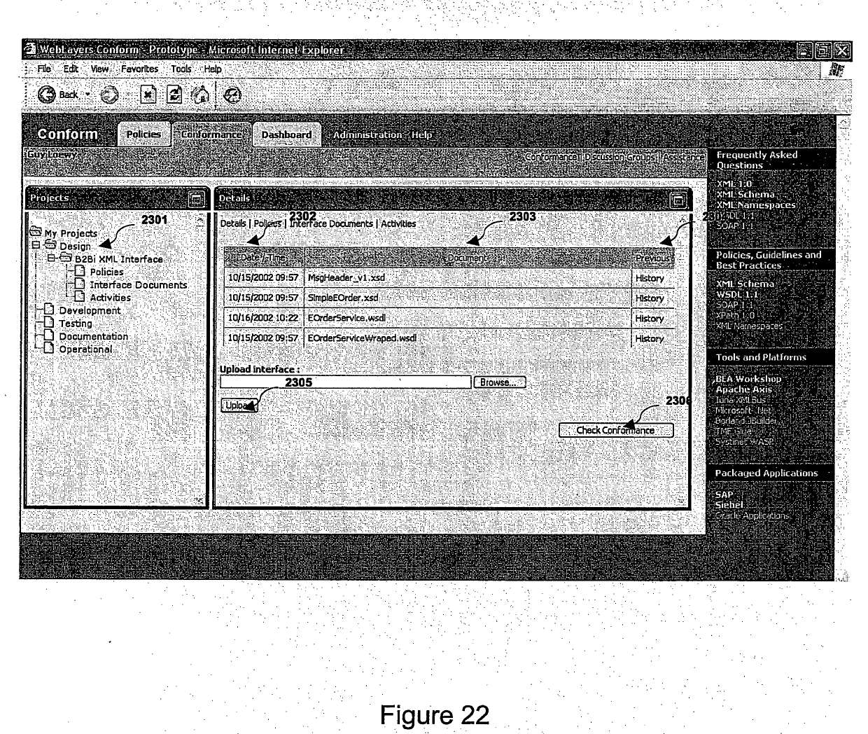

FIG. 22 is an example presentation of policy assignment screen, according to one embodiment of the present invention. The system server may provide the user with Project information (2701), and the policies that the user is authorized to assign (2702). The system also provides assignment operations bottoms (2703) such as adding Policies from, for example, the All Policies window (2702) to the Project Policies (2704) window. The user may also, for example, Remove, Add All, or Remove All policies. One the user is satisfied with the policies assigned to the project he/she may update the information to the system via the Update link (2705).

The interface document or interface documents may be assigned or associated with a group such as a project, and based on the association or inclusion within such group, the interface document may be evaluated based on a set of policies (when used in this document, set may include one item) that are also associated with the set of policies. For example, a project including interface documents meant mainly for internal use, within an organization, may have certain standards and security policies which are at a certain level. The policies associated with that project may thus reflect these standards. When an interface document associated with the project is evaluated, the policies associated with the project will automatically be applied, and the document will be evaluated in light of the policies. A project including interface documents meant mainly for interface with external personnel or systems, external to an organization, may have higher standards and security policies. The policies associated with that project may reflect these standards, and interface documents associated with the externally oriented project may be evaluated in light of this separate set of policies. Policies may be included in more than one project, so different sets of policies may overlap.

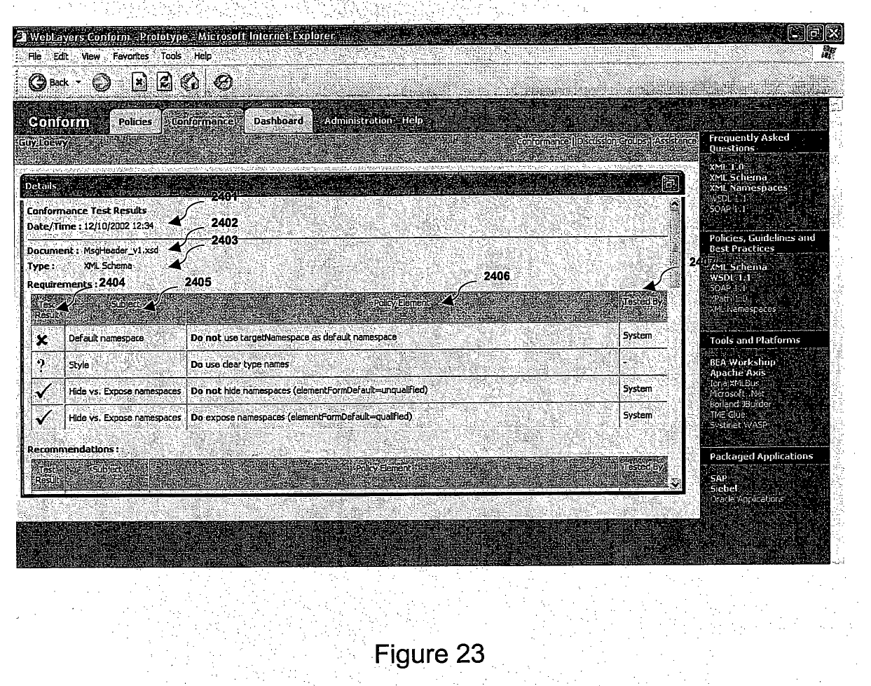

FIG. 23 is an example representation of how a user may upload interface documents to the conformance system, according to one embodiment of the present invention. The upload interface screen may include, for example, Project Name, which is the name of the project the user is currently working on (2301); a list of interface documents; Last Update Date, which is the date the last update of the interface document took place (2302) (e.g., any time an interface document is uploaded to the system the last update date may get updated); Document Name, which is the name of the interface document file (2303); Document History, which may include the history, versions, test results, etc. of an interface document (2304); Upload Interface Document Option, which is the upload document option for choosing and uploading documents (2305); and Initiate Conformance Test Option, which includes the initiate conformance test option (2306). By choosing this option a conformance process may be initiated. Based on the project definitions a manual or system conformance test may be initiated.

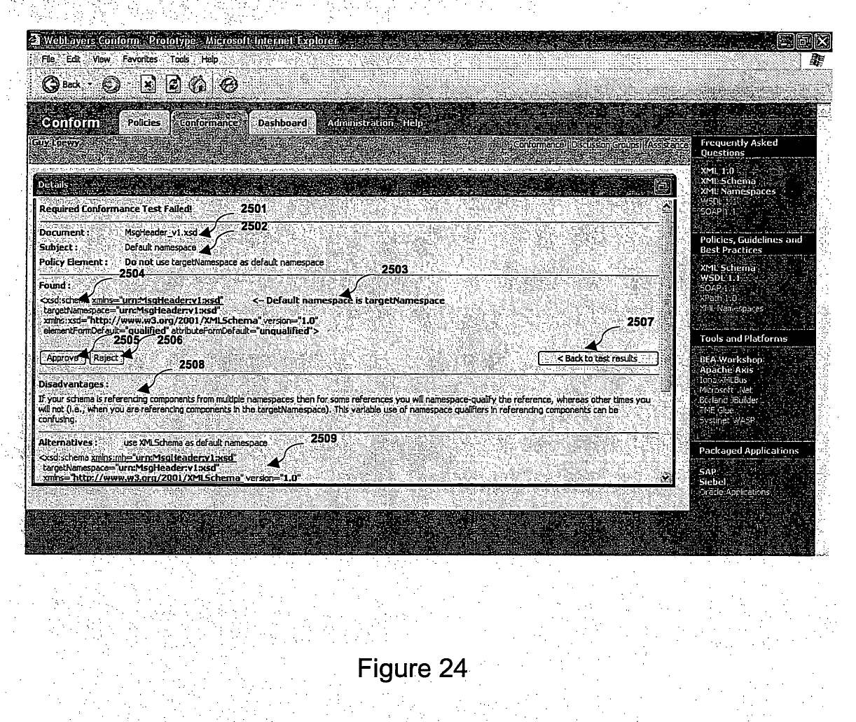

FIG. 24 is an example representation of how conformance test results are presented to the user, according to an embodiment of the present invention. The conformance test results screen may include, for example: Test Date/Time, which is the date and time in which the test report was generated (2401); Test Document Name, which is the name of the document that the following test result refer to (2402); and Test Document Type, which may be the type of the document that was tested (2403).

A list of requirements and recommendations may be included, which may include a Test Result, which is the conformance test result of the test interface document with a specific Policy Element (2404). The result may be that the conformance “Passed”, “Not Passed” or that additional information is required in order to determine conformance.

Test Status may be provided (not shown in FIG. 24), which may include the test result status based on the user's behavior and decisions. The result status, for example, may have a status of “Confirmed”, wherein the user confirmed that he/she intends to resolve this conformance issue; “Exception”, wherein the user is requesting an exception from conforming to the specific Policy Element; “Waiting”, wherein the user requested additional information and is waiting for a response; “Viewed”, wherein the user viewed the test result description, but did not respond; and “Not Viewed”, where the user did not even view this test result.

Other elements may include, for example: Policy Element Subject, which is the subject the Policy Element is dealing with (2405). For example Default Namespace, Style, etc.; Policy Element short description, which is the short description of a Policy Element including operator and other configuration parameter values (2406); and Tested by, which indicates the system or user that tested conformance to the Policy Element (2407). This may include self-conformance, reviewer user conformance, or system conformance.

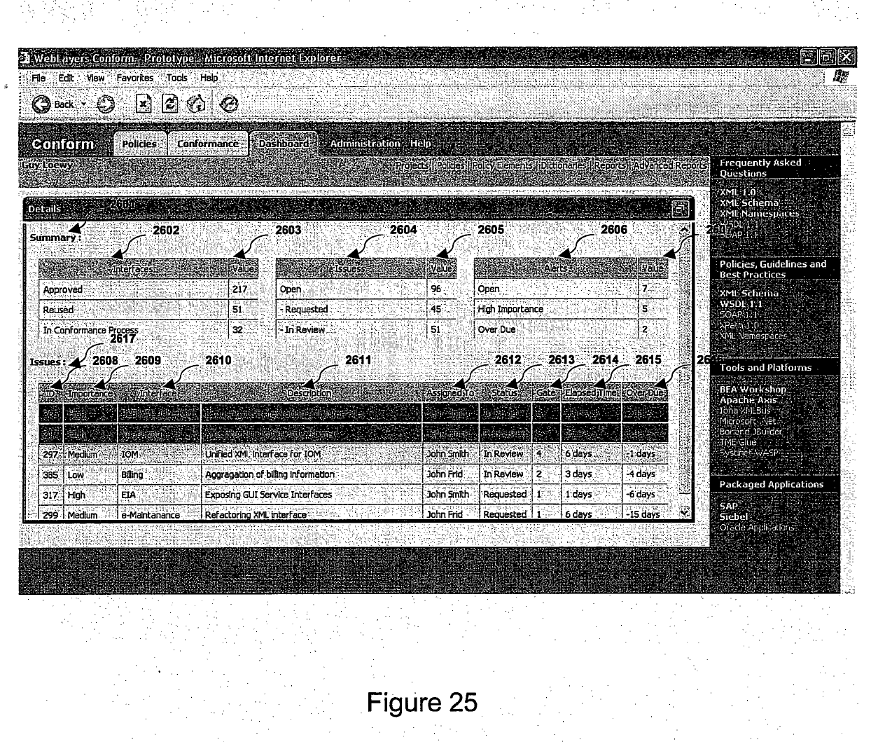

FIG. 25 is an example representation of a detailed conformance test result for a Policy Element, according to one embodiment of the present invention. The detailed policy element test result screen may include, for example: Document Name, which is the name of the test document (2501); Policy Element Subject, which is the subject the Policy Element is dealing with (2502), for example, Default Namespace, Style, etc.; Policy Element short description, which is the short description of a Policy Element including operator and other configuration parameter values (2503); Test findings, which may include the findings during the conformance test of the test document (2504). The findings explain where exactly in the document the test document was not conforming.

The test screen may further include, for example, a Confirm function, which may provide the option to confirm that the user intends to correct the document based on the Policy Element description (2505); Request Exception, which may provide the option to request exception for the document so that it may not have to conform to the Policy Element (2506); Back to test results, which may provide the option to leave the detailed policy element test result without deciding anything (2507); Explanations, which may include the explanation for why the Policy Element was configured the way it was (2508), including disadvantages, advantages, etc.; and Alternatives, which may provide suggestions of alternative ways to construct the document in order for the document to “Pass” the conformance tests (2509).

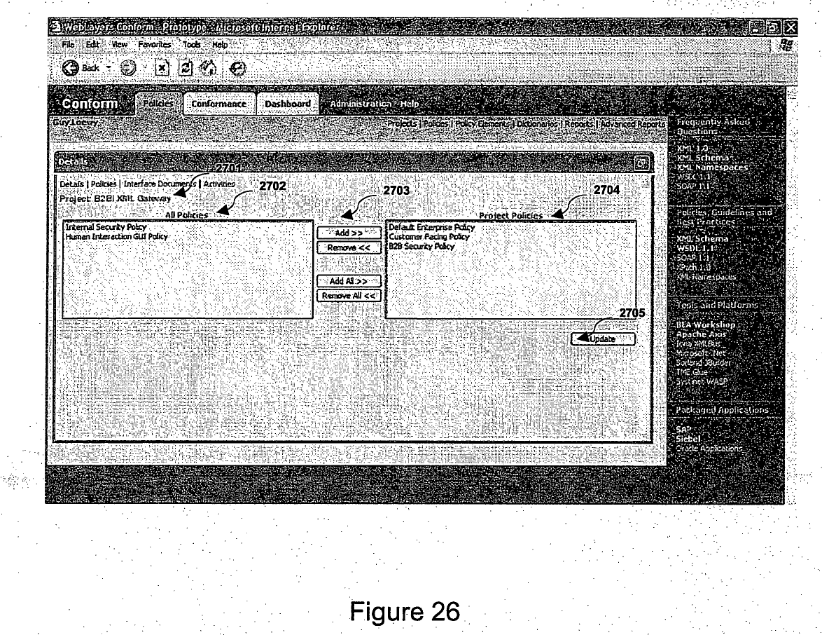

FIG. 26 is an example representation of a governance dashboard, according to one embodiment of the present invention. In this example the dashboard includes a Summary section (2601) and an Issues section (2617). Summary (2601) may provide the user with easy to read information, for example processed and analyzed information, from different information elements including, for example, status of Interfaces (2602) and the Values (2603) for Interface status's—including Interfaces Approved (in this example the value which means the number of interfaces approved is 217), the value of interfaces Reused, and the value of interfaces in Conformance process etc.

Another example of the summarized information is the Issues category (2604) (this term may be defined by the user). A user may define issues, for example, as Exception Requests or other suitable names. In this example the Value (2605) for the Open Issues is 96 and for the Requested Issues is 45.

Another example of summarized information is the Alert category (2606), which may be configured by the user. The Alerts may include any system alert that was sent to users, including cost alerts, exception requests alerts, conflict alerts etc. In this example the open alerts value (2607) is 7, which represents that there are 7 alerts open, of which 5 are of high importance, and 2 are overdue.

The Issues section (2617) may include, for example, more detailed information about the Issues that are presented in (2604). The information may include ID (2608), which represents the issue unique identification given by the system; the Importance (2609), that represents the importance level of an issue (for example if the issues importance level is High, Medium or Low); the Interface (2610), which represents the Interface name; the Description (2611), which provides short description of the Interface; the Assigned to (2612), that provides the reviewer that was assigned to review this interface; the Status (2613), which provides the status of the review; the Gate (2614), which represents the user relevant software development gate information; the Elapsed Time (2615), which represents the time passed since the Interface was submitted for review presented in this example in days; and Over Due (2616), which represents the time the review process of a specific interface is over due. Other information may be presented.

It is noted that, in addition to the views and forms presented in the above described screen shots, other ways of presenting and accepting data to the user may be used, and other sets of data may be presented or accepted.

While the invention has been described with respect to a limited number of embodiments, it will be appreciated that many variations, modifications and other applications of the invention may be made which are within the scope and spirit of the present invention.

What is claimed is:

1. A method, comprising:
configuring a policy, said policy including a policy element, said policy applicable to a plurality of interface document types; and
comparing one of a plurality of interface documents of said plurality of interface document types to said policy.

2. The method of claim 1, comprising conforming said interface document to said policy.

3. The method of claim 1, wherein said configuring a policy comprises:
creating a policy in a computing system;
defining a policy element;
providing configuration parameters for said policy element; and
providing a policy definition, said definition including one or more policy elements.

4. The method of claim 3, comprising resolving conflicts between policy elements in a selected policy.

5. The method of claim 1, wherein comparing said plurality of interface documents of said plurality of interface document types to said policy comprises initiating an automated compliance test on said interface document.

6. The method of claim 1, wherein comparing said plurality of interface documents of said plurality of interface document types to said policy comprises:
uploading an interface document;
performing a compliance test on said interface document; and
reporting said results of said compliance test.

7. The method of claim 2, wherein said conforming said interface document to said policy comprises:
raising an exception request to a policy element;
if a policy element is not approved to be an exception, correcting said interface document; and
if a policy element is approved to be an exception, granting conformance to said policy element.

8. The method of claim 2, wherein said conforming said interface document to said policy comprises initiating a compliance test such that a pass or not pass result is determined, based on the information in said interface document and said policy element.

9. The method of claim 2, wherein said conforming said interface document to said policy comprises:
in the case where an interface document does not provide enough information to determine whether a said policy element is to be passed, checking whether said policy element provides a guided interaction process; and
if said policy element does provide a guided interaction process, determining whether to pass the conformance of said interface document to said policy element in accordance with a response to said guided interaction process.

10. The method of claim 2, wherein said conforming said interface document to said policy comprises reviewing said interface document for conformance to said policy element, by a user.

11. The method of claim 2, wherein said conforming said interface document to said policy comprises determining conformance based on a process selected from the group consisting of using information in said interface document and said policy element, using a guided interaction process, and reviewing said interface document for conformance to said policy element by a user.

12. The method of claim 2, wherein said conforming said interface document to said policy comprises determining conformance based on information in said interface document and said policy element, and based on a guided interaction process.

13. The method of claim 1, comprising:
initiating an exception request to said policy;
distributing said exception request to a relevant user;
performing an analysis on the impact of said exception request; and
resolving said exception request by granting or not granting an approval.

14. The method of claim 1, comprising
providing a user with a list of potentially reusable interfaces components;
analyzing potential reusability of interfaces components, based on a provided list and project information; and
determining which interfaces components may be re-used.

15. The method of claim 14, comprising executing a cost analysis associated with selected reusable interfaces components.

16. The method of claim 14, comprising alerting relevant users of the assignment of reusability guidelines to an interface document.

17. The method of claim 1, comprising:
when a change in a policy element is made, testing whether said policy element change conflicts with other policy elements that are defined in a policy; and if there is a conflict, generating a conflict alert.

18. The method of claim 17, comprising analyzing the impact of solving said conflict.

19. The method of claim 17, comprising:
generating an impact analysis report comprising a description of an impact of a conflict on an interface document.

20. The method of claim 17, comprising, after a conflict has been resolved, applying said policy element change to a policy.

21. The method of claim 1, comprising:
accepting an escalation indication from a user;
notifying relevant users about an escalation process being initiated for an interface document; and
receiving a response from a relevant user escalating said response.

22. The method of claim 1, comprising:
selecting a policy to be assigned;
assigning said policy to an interface document.

23. The method of claim 22, comprising, where a plurality of policies are assigned to an interface document, determining if conflicts occur between policy elements of said plurality of policies.

24. The method of claim 22, comprising:
alerting relevant users of said policy assignment; and
negotiating said policy assignment between said relevant users.

25. The method of claim 1, comprising:
defining global cost parameters for a set of interface documents;
defining alerting rules associated with said global cost parameters;
recording information relating to development of said interface documents;
analyzing recorded information according to said global cost parameters; and
generating alerts to relevant users, according to said information analysis.

26. A method, comprising:
associating in a computer system a policy to a plurality of interface document types;
uploading interface documents created in one of said plurality of interface document types; and
analyzing said interface documents according to said policy.

27. The method of claim 26, comprising conforming said interface documents to said policy.

28. The method of claim 26, comprising assigning a set of policies to a project, said set of policies being selected from a plurality of sets of policies.

29. The method of claim 26, comprising alerting a relevant user about the conformance status of an interface document to said policy.

30. The method of claim 27, wherein said conforming comprises an automated conformance procedure.

31. The method of claim 27, wherein said conforming comprises a guided conformance procedure.

32. The method of claim 26, comprising managing exception requests for said policy.

33. The method of claim 32, wherein said managing comprises:
initiating an exception request to said policy;
distributing said exception request to a relevant user;
performing an analysis on the impact of said exception request; and
resolving the exception request by granting or not granting an approval.

34. The method of claim 26, comprising initiating a reusability procedure in a distributed architecture.

35. The method of claim 26, comprising managing potential policy conflicts in a distributed architecture.

36. The method of claim 26, comprising performing an impact analysis on a plurality of interface documents in said distributed architecture.

37. The method of claim 26, comprising managing cost parameters associated with development of said interface documents.

38. A method comprising:
creating a policy including conformance rules, the policy applicable to an interface document of a certain type, said type being one of a plurality of types, the policy to be applied to interface documents.

39. The method of claim 38, wherein the policy is applicable to a plurality of document types.

40. The method of claim 38, comprising conforming interface documents from a plurality of interface document types.

41. A method comprising:
assigning a set of policies to a project, said set of policies being selected from a plurality of sets of policies; and
alerting a relevant user about said assigned set of policies.

42. The method of claim 41, comprising conducting a conflict resolution for said assignment of said set of policies to said project.

43. The method of claim 41, comprising assigning a set of policies to a plurality of projects in a distributed environment.

44. The method of claim 41, comprising assigning a set of interface documents to said project.

45. The method of claim 41, wherein when an interface document associated with a project is evaluated, it is evaluated in light of policies associated with said project.

46. A method comprising:
storing a plurality of policies in a computer system, each policy including at least a set of conformance rules, each policy applicable to a plurality of interface document types;
assigning a policy to said plurality of interface document types; and
conforming interface documents from said plurality of interface document types to said policy.

47. The method of claim 46, wherein said conformance rules are defined by policy elements.

48. The method of claim 46, wherein said interface document types are selected from the group consisting of Extensible Markup Language, Simple Object Access Protocol, and Web Services Description Language (WSDL) documents.

49. A system comprising:
a controller to:
configure a policy, said policy including a policy element, said policy applicable to a plurality of interface document types in a distributed architecture; and
compare an interface document of said plurality of interface document types to said policy.

50. The system of claim 49, wherein said controller is to conform said interface document to said policy.

51. The system of claim 49, wherein said controller is to:
define a policy to a computing system;
define a policy element;
provide configuration parameters for said policy element; and
provide a policy definition, said definition including one or more policy elements.

52. The system of claim 49, wherein said controller is to initiate an automated compliance test on said interface document.

53. The system of claim 49, wherein said controller is to resolve conflicts between policy elements in a selected policy.

54. The system of claim 49, wherein said controller is to resolve conflicts between policy elements in a plurality of policies that are assigned to an interface document.

55. The system of claim 49, wherein said controller is to raise an exception request to a policy element.

56. The system of claim 49, wherein said controller is to enable re-usage of interfaces components.

57. The system of claim 49, wherein said controller is to generate a conflict alert.

58. The system of claim 49, wherein said controller is to escalate conformance to a policy.

59. The system of claim 49, wherein said controller is to assign a policy.

60. A system, comprising:
a controller to:
associate in a computer system a policy to a plurality of interface document types;
upload interface documents created in an interface document type to a computer system; and
analyze said interface documents according to said policy.

61. The system of claim 60 wherein the controller is to assign a set of interface documents to a project.

62. The system of claim 60 wherein the controller is to, when an interface document associated with a project is evaluated, evaluate the interface document in light of policies associated with said project.

63. The system of claim 60, wherein said controller is to conform said interface documents to said policy.

64. The system of claim 60, wherein said controller is to assign in said computer system a set of policies to a project, said set of policies being selected from a plurality of sets of policies.

65. The system of claim 60, wherein said controller is to alert a relevant user about the conformance status of an interface documents to said policy.

66. The system of claim 60, wherein said controller is to process exception requests.

67. The system of claim 60, wherein said controller is to re-use interface components.

68. The system of claim 60, wherein said controller is to manage potential policy conflicts.

69. A system, comprising:
a controller to:
create a policy including conformance rules, the policy applicable to a document of a certain type, said type being one of a plurality of types, the policy being capable of enabling integration of interface documents in a distributed architecture.

70. The system of claim 69, wherein said controller is to conform interface documents from a plurality of interface document types.

71. A system, comprising:
a controller to:
assign a set of policies to a project, said set of policies being selected from a plurality of sets of policies; and
alert a relevant user about said assigned set of policies.

72. The system of claim 71, wherein said controller is to conduct a conflict resolution for said assignment of said set of policies to said project.

73. A system, comprising:
a controller to:
store a plurality of policies in a computer system, each policy including at least a set of conformance rules, each policy applicable to a plurality of interface document types; and
assign a policy to said plurality of interface document types.

74. The system of claim 73, wherein said controller is to conform interface documents from said plurality of interface document types to said policy.

75. The system of claim 73, wherein said controller is to define conformance rules according to policy elements.

76. A computer system, comprising:
a user interface engine;
a policy element configuration engine;
a project definition engine;
a dictionaries and vocabularies matching engine; and
an application programming interface.

77. The computer system of claim 76, comprising a dashboard engine.

78. A data repository, comprising:
a policy element library;
a policy library; and
interface document information.

79. The data repository of claim 78, comprising user information.
